(19) United States
(12) Patent Application Publication
(10) Pub. No.: US 2009/0243978 A1
(43) Pub. Date: Oct. 1, 2009

(54) Display apparatus

(75) Inventors: Tetsuro Yamamoto, Kanagawa (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/379,844

(22) Filed: Mar. 3, 2009

(30) Foreign Application Priority Data
Mar. 31, 2008 (JP) 2008-089981

(51) Int. Cl. G09G 3/30; G06F 3/038

(52) U.S. Cl. 345/76; 345/211

(57) ABSTRACT

A display apparatus, includes: a plurality of pixel circuits disposed in rows and columns and each including a driving transistor configured to produce driving current, an electro-optical element connected to an output terminal of the driving transistor, a storage capacitor configured to store information corresponding to a signal amplitude of an image signal, and a first sampling transistor and a second sampling transistor connected in cascade connection for writing the information corresponding to the signal amplitude into the storage capacitor; a vertical scanning section configured to produce a vertical scanning pulse for vertically scanning the pixel circuits; a plurality of vertical scanning lines connected to the vertical scanning section; a horizontal scanning section configured to supply the image signal to the pixel circuits in synchronism with the vertical scanning by the vertical scanning section; and a plurality of horizontal scanning lines connected to the horizontal scanning section.

### BACKGROUND OF THE INVENTION

1. Field of the Invention

This invention relates to a display apparatus which includes a plurality of pixel circuits or pixels each including an electro-optical element serving as a display element or a light emitting element, and more particularly to a display apparatus which includes a plurality of pixel circuits each including a display element formed from an electro-optical element of the current driven type whose emitted light luminance varies in response to the magnitude of a driving signal and further including an active element for carrying out display driving in a unit of a pixel.

2. Description of the Related Art

A display apparatus is available which includes, as a display element of a pixel, an electro-optical element whose emitted light luminance varies in response to a voltage applied thereto or to current flowing therethrough. A representative one of electro-optical elements whose emitted light luminance varies in response to a voltage applied thereto is a liquid crystal display element. Meanwhile, a representative one of electro-optical elements whose emitted light luminance varies in response to current flowing therethrough is an organic electroluminescence (hereinafter referred to simply as organic EL) element such as an organic light emitting diode (OLED). An organic EL display apparatus which uses the latter organic EL element is a self-luminous display apparatus which uses an electro-optical element, which is a self-luminous element, as a display element of a pixel.

An organic EL element includes a lower electrode, an upper electrode, and an organic thin film or organic layer disposed between the lower and upper electrodes and formed from an organic hole transport layer and an organic light emitting layer laminated with each other. The organic EL element utilizes a phenomenon that the organic thin film emits light when an electric field is applied thereto, and exhibits a gradation of color development by controlling the value of current to flow through the organic EL element.

In an organic EL display apparatus which uses an element of the current driven type such as an organic EL element as an electro-optical element, a driving signal in the form of a voltage signal corresponding to an input image signal fetched into a storage capacitor is converted into a current signal by a driving transistor, and the driving current is supplied to the organic EL element.

For example, in order for the emitted light luminance of the organic EL element to be invariable, it is significant to fix the driving current corresponding to the input image signal.

However, the threshold voltage or the mobility of an active element such as a driving transistor for driving the electro-optical element disperses depending upon the process fluctuation. Further, the characteristic of the electro-optical element such as an organic EL element fluctuates as time passes. Such a characteristic dispersion of the active element for driving or a characteristic fluctuation of the electro-optical element has an influence on the emitted light luminance even where a fixed current driving method is applied.

Therefore, a mechanism for compensating for the luminance fluctuation arising from such a characteristic fluctuation of the driving active element or the electro-optical element as described above in each pixel circuit in order to control the emitted light luminance uniform over the entire screen image of a display apparatus is examined.

A pixel circuit for an organic EL element which incorporates such a mechanism as described above is disclosed, for example, in Japanese Patent Laid-Open No. 2006-215213 (hereinafter referred to as Patent Document 1). The pixel circuit incorporates a threshold value correction function for keeping driving current for a driving transistor fixed even if the threshold voltage of the driving transistor suffers from dispersion or aged deterioration. The pixel circuit further incorporates a mobility correction function for keeping the driving current fixed even if the mobility of the driving transistor suffers from dispersion or aged deterioration. The pixel circuit further incorporates a bootstrap function for keeping the driving current for an organic EL element fixed even if the current-voltage characteristic of the organic EL element suffers from aged deterioration.

On the other hand, if it is intended to reduce the cost, then it seems a possible countermeasure to reduce the number of scanning lines to be led out from various scanning circuits provided on a peripheral portion of a pixel array section while the number of pixels is not reduced. In this instance, a plurality of pixels in different columns are allocated to one horizontal scanning line or a plurality of pixels in different rows are allocated to one vertical scanning line such that a scanning signal outputted from a scanning circuit is used commonly by the plural pixels.

Reduction of the number of scanning lines to be wired in the pixel array section can reduce the cost by an amount corresponding to the cost for the circuitry for driving the reduced scanning lines. It seems a possible idea to adopt, for such reduction of the number of scanning lines, a mechanism used in a liquid crystal display apparatus for reducing the number of wiring lines to be led out without reducing the number of pixels. For example, if attention is paid to the horizontal scanning side, it is a possible idea to adopt a mechanism wherein a signal line is commonly used by a plurality of pixels to achieve reduction of the cost. The mechanism is disclosed, for example, in Japanese Patent Laid-Open No. 2006-215322 (hereinafter referred to as Patent Document 2).

In the mechanism disclosed in Patent Document 2, a signal line is used commonly by a plurality of pixels adjacent each other and two image signals are inputted to one pixel to rewrite an image signal.

### SUMMARY OF THE INVENTION

However, the mechanism disclosed in Patent Document 2 cannot be incorporated into an apparatus which carries out mobility correction by carrying out signal writing while current is supplied. This is because, if an image signal voltage is inputted to the gate of the driving transistor twice or more, then the mobility correction is carried out for the image signal inputted for the first time and a normal mobility correction operation cannot be carried out for the image signal or signals inputted for the second time or later to the gate of the driving transistor.

On the other hand, the mechanism disclosed in Patent Document 1 demands a wiring line for supplying a potential for correction, a switching transistor for correction and a switching pulse for driving the switching transistor. Thus, the mechanism adopts a five-transistor driving configuration including five transistors including a driving transistor and a sampling transistor. Therefore, the configuration of the pixel circuit is complicated including many vertical scanning lines and includes many components, which makes an obstacle to enhancement of the definition of the display apparatus. As a result, the five-transistor configuration makes it difficult to apply the display circuit to a display apparatus which is used in a small-sized electronic apparatus such as a mobile apparatus.

Therefore, it is demanded to provide a display apparatus wherein an image signal line or an image signal can be used commonly among a plurality of pixels or columns without increasing the number of control lines or control signals in a horizontal scanning system.

Also it is demanded to provide a display apparatus which can be improved in definition through simplification of a pixel circuit. It is further demanded to provide a display apparatus wherein a pixel circuit can be simplified while suppressing a variation in emitted light luminance caused by characteristic dispersion of a driving transistor or an electro-optical element.

According to the embodiment of the present invention, in order to allow an image signal line, which is one of a scanning line to be used commonly among a plurality of pixels (in short, a plurality of columns), there is provided a display apparatus including a pixel array section in which a plurality of pixel circuits are disposed in rows and columns. In the pixel circuit, the electro optical element generate the driving current based on a information stored in the storage capacitor by the driving transistor, flow it to the electro optical element, thereby emit light. The pixel array section includes a driving transistor for producing driving current, an electro-optical element connected to an output terminal of the driving transistor, a storage capacitor for storing information corresponding to a signal amplitude of an image signal, and a first sampling transistor and a second sampling transistor connected in cascade connection for writing the information corresponding to the signal amplitude into the storage capacitor. The pixel array section further includes a vertical scanning section for producing a vertical scanning pulse for vertically scanning the pixel circuits, a plurality of vertical scanning lines connected to the vertical scanning section, a horizontal scanning section for supplying the image signal to the pixel circuits (particularly, the first sampling transistor and the second sampling transistor) in synchronism with the vertical scanning by the vertical scanning section, and a plurality of horizontal scanning lines connected to the horizontal scanning section. The vertical scanning section includes a writing scanning section for at least scanning the pixel circuits vertically to produce a writing scanning pulse for writing the information corresponding to the signal amplitude into the storage capacitor, and the vertical scanning lines includes a plurality of writing scanning lines connected to the writing scanning section. Each of the horizontal scanning lines is wired such that the image signal for signal writing from the horizontal scanning section is supplied commonly to the input terminals of those of the first sampling transistors which are included in a plurality of columns. The controlling input terminals of those of the second sampling transistors which belong to each of sets each including the plurality of columns to which the image signal is supplied commonly is connected to the vertical scanning lines such that the vertical scanning pulses for the rows different from each other of other sets than the set to which the second sampling transistors belong are supplied from the vertical scanning section to the controlling input terminals of the second sampling transistors.

In short, in order to allow an image signal line, which is a scanning line of a horizontal scanning system, or an image signal to be used commonly among a plurality of columns, the sampling transistor is formed in a double-gate configuration including transistors connected in two stages. Then, the image signal line for the plural columns of an object of common use is connected commonly to the signal input terminals of the sampling transistors of the double-gate configuration on the image signal line side.

On the other hand, the second sampling transistors are connected to the vertical scanning lines of the same types or different types in different rows in different sets except the set for common use to which the self row belongs such that the image signal is supplied to the controlling input terminal of the driving transistors in synchronism with ordinary vertical scanning for each one row by the combination of the first and second sampling transistors. Incidentally, the term “different types” does not signify that all vertical scanning lines connected to the controlling input terminals of the second sampling transistors in the set are types different from each other, but signifies that the controlling input terminals of the second sampling transistors in the set are connected to at least two types of scanning lines.

In the display apparatus, the sampling transistor has a double-gate structure, and the signal input terminals of the sampling transistor of the double-gate structure are connected commonly to an image signal line of an object of common use such that the one image signal line is used commonly by the pixel circuits in the plural columns. Meanwhile, as regards the vertical scanning lines for controlling the second sampling transistors, existing vertical scanning lines of the same types or different types in different rows in different sets except the set used commonly to which the self row belongs are allocated.

Therefore, since an image signal to be supplied to the pixel circuits through the image signal line is used commonly by the pixel circuits in the plural columns without increasing the number of control lines or control signals, reduction in cost can be anticipated.

### BRIEF DESCRIPTION OF THE DRAWINGS

FIG. 1 is a block diagram showing a general configuration of an active matrix type display apparatus as a form of a display apparatus according to the present embodiment;

FIGS. 2 and 3 are block diagrams showing pixel circuits as first and second comparative examples, respectively;

FIG. 4A is a graph illustrating an operating point of an organic EL element and a driving transistor;

FIGS. 4B to 4D are graphs illustrating an influence which characteristic dispersion of an organic EL element or a driving transistor has on driving current;

FIG. 5 is a block diagram showing a pixel circuit as a third comparative example;

FIG. 6 is a timing chart illustrating a basic example of driving timings of the pixel circuit shown in FIG. 5;

FIG. 7A is a circuit diagram showing a reference circuit to a pixel circuit of the active matrix type display apparatus of FIG. 1;

FIG. 7B is a timing chart illustrating driving timings where the reference circuit of FIG. 7A is applied to the pixel circuit of the third comparative example of FIG. 5;

FIG. 8A is a block diagram showing a general configuration of a connection relationship of scanning lines and pixel circuits of an organic EL display apparatus according to a first embodiment of the present invention;

FIG. 8B is a view illustrating details of the connection relationship of the pixel circuits and the scanning lines illustrated in FIG. 8A;

FIG. 8C is a timing chart illustrating driving timings of the organic EL display apparatus of FIG. 8A;

FIG. 9A is a block diagram showing a general configuration of a connection relationship of scanning lines and pixel circuits of an organic EL display apparatus according to a second embodiment of the present invention;

FIG. 9B is a timing chart illustrating driving timings of the organic EL display apparatus of FIG. 9A;

FIG. 10A is a block diagram showing a general configuration of a connection relationship of scanning lines and pixel circuits of an organic EL display apparatus according to a third embodiment of the present invention;

FIG. 10B is a timing chart illustrating driving timings of the organic EL display apparatus of FIG. 10A;

FIG. 11A is a block diagram showing a general configuration of a connection relationship of scanning lines and pixel circuits of an organic EL display apparatus according to a fourth embodiment of the present invention;

FIG. 11B is a view illustrating details of the connection relationship of the pixel circuits and the scanning lines illustrated in FIG. 11A;

FIG. 11C is a timing chart illustrating driving timings of the organic EL display apparatus of FIG. 11A;

FIG. 12A is a block diagram showing a general configuration of a connection relationship of scanning lines and pixel circuits of an organic EL display apparatus according to a fifth embodiment of the present invention;

FIG. 12B is a view illustrating details of the connection relationship of the pixel circuits and the scanning lines illustrated in FIG. 12A; and

FIG. 12C is a timing chart illustrating driving timings of the organic EL display apparatus of FIG. 12A.

### DETAILED DESCRIPTION OF THE PREFERRED EMBODIMENTS

### <General Configuration of the Display Apparatus>

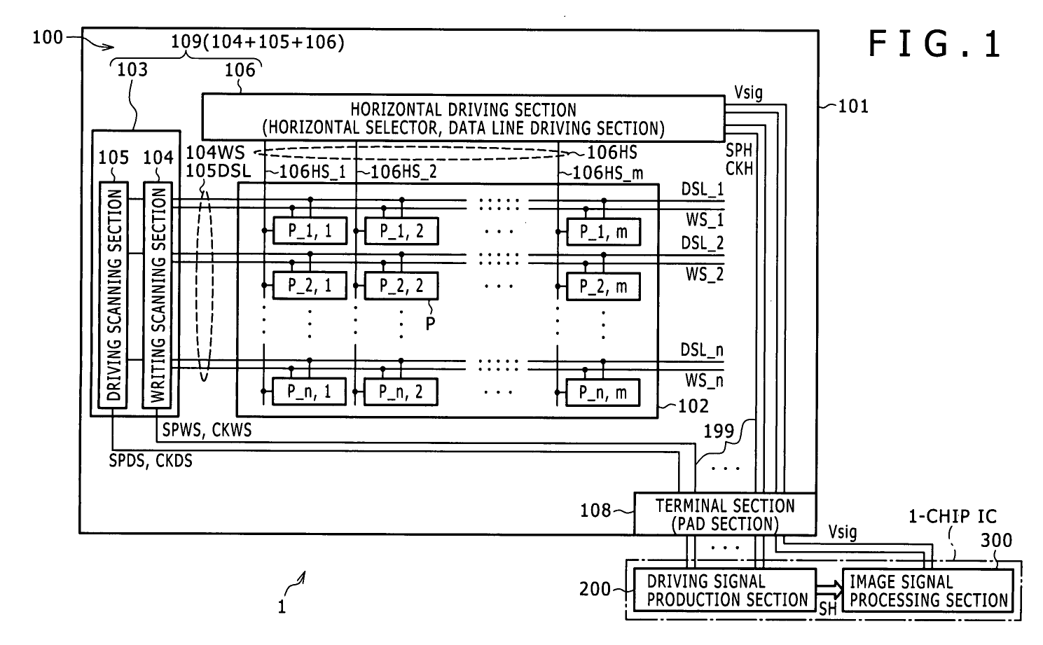

FIG. 1 shows a general configuration of an active matrix type display apparatus as a form of a display apparatus according to the present embodiment. In the present form, the display apparatus is applied to an active matrix type organic electro luminescence (EL) display apparatus hereinafter referred to simply as “organic EL display apparatus.” In the organic EL display apparatus, an organic EL element is used as a display element, an electro-optical element or a light emitting element of each pixel, and a polycrystalline silicon thin film transistor (TFT) is used as an active element of each pixel. Further, the organic EL elements are formed on a semiconductor substrate on which the thin film transistors are formed. Such an organic EL display apparatus as just described is utilized as a display section in a portable music player or some other electronic apparatus which utilizes a recording medium such as a semiconductor memory, a minidisc (MD) or a cassette tape.

Referring to FIG. 1, the organic EL display apparatus 1 shown includes a display panel section 100 wherein a plurality of pixel circuits (also referred to as pixels) P each including an organic EL element not shown as a display element are disposed so as to form an effective image area having a display aspect ratio of X:Y such as, for example, 9:16. The organic EL display apparatus 1 further includes a driving signal production section 200 as an example of a panel controlling section and an image signal processing section 300 which generate various pulse signals for controlling and driving the display panel section 100. The driving signal production section 200 and the image signal processing section 300 are built in a one-chip IC (integrated circuit).

For example, where the organic EL display apparatus 1 is formed as a display apparatus of the panel type, popularly it is generally configured such that it includes a pixel array section 102, a control section 109, and a driving signal production section 200 and an image signal processing section 300. The pixel array section 102 includes a plurality of elements such as TFTs and electro-optical elements disposed in rows and columns and forming pixel circuits P. The control section 109 is disposed on a periphery of the pixel array section 102 and includes, as principal components thereof, scanning sections including a horizontal driving section and a vertical driving section connected to scanning lines for driving the pixel circuits P. The driving signal production section 200 and the image signal processing section 300 generate various signals for driving and controlling the control section 109 to operate.

The display panel section 100 is configured such that the pixel array section 102 wherein the pixel circuits P are arrayed in a matrix of n rows×m columns, a vertical driving section 103 which is an example of a vertical scanning section for scanning the pixel circuits P in the vertical direction, a horizontal driving section 106 as an example of a horizontal scanning section for scanning the pixel circuits P in the horizontal direction, a terminal section or pad section 108 for the external connection and so forth are formed in an integrated fashion. The horizontal driving section 106 is referred to also as horizontal selector or data line driving section. In short, such peripheral driving circuits as the vertical driving section 103 and the horizontal driving section 106 are formed on a substrate 101 on which the pixel array section 102 is formed.

The vertical driving section 103 includes a writing scanning section (write scanner WS; Write Scan) 104 and a driving scanning section (drive scanner DS; Drive Scan) 105 which functions as a power supply scanner having a power supply capacity. The vertical driving section 103 and the horizontal driving section 106 cooperatively form the control section 109 for controlling writing of a signal potential into a storage capacitor, a threshold value correction operation, a mobility correction operation and a bootstrap operation.

To the terminal section 108, various pulse signals are supplied from the driving signal-production section 200 disposed outside the organic EL display apparatus 1. Similarly, an image signal Vsig is supplied from the image signal processing section 300 to the terminal section 108. Where the organic EL display apparatus 1 is ready for color display, image signals of different colors, in the present example, image signals Vsig_R, Vsig_G and Vsig_B of the primary colors of R (red), G (green) and B (blue), are supplied to the terminal section 108.

As an example, necessary pulse signals such as shift start pulses SPDS and SPWS and vertical scanning clocks CKDS and CKWS as an example of write starting pulses in the vertical direction are supplied as pulse signals for vertical driving. Meanwhile, as pulse signals for horizontal driving, necessary pulse signals such as a horizontal start pulse SPH and a horizontal scanning clock CKH which are an example of write starting pulses in the horizontal direction are supplied.

In the pixel array section 102, scanning lines on the vertical scanning side, that is, vertical scanning lines including writing scanning lines 104WS and power supply lines 105DSL and scanning lines on the horizontal scanning side, that is, horizontal scanning lines including image signal lines or data lines 106HS, are formed. An organic EL element not shown and a thin film transistor (TFT) for driving the organic EL element are formed at each of intersecting points between the scanning lines for the vertical scanning and the horizontal scanning. A pixel circuit P is formed from a combination of the organic EL element and the thin film transistor.

In particular, for the pixel circuits P arrayed in a matrix, writing scanning lines 104WS_1 to 104WS_n for n rows which are driven with a writing driving pulse WS by the writing scanning section 104 and power supply lines 105DSL_1 to 105DSL_n for n rows which are driven with a power supply driving pulse DSL by the driving scanning section 105 are wired for individual pixel rows.

The writing scanning section 104 and the driving scanning section 105 successively select the pixel circuits P through the writing scanning lines 104WS and the power supply lines 105DSL based on a pulse signal of the vertical driving system supplied from the driving signal production section 200. The horizontal driving section 106 samples a predetermined potential in the image signal Vsig through the horizontal driving signal line 106HS and stores the sampled predetermined potential into the storage capacitor of the selected pixel circuits P based on a pulse signal of the horizontal driving system supplied from the driving signal production section 200.

The organic EL display apparatus 1 in the present form can be driven by line-sequential driving, plane-sequential driving or some other driving method. In particular, for example, the writing scanning section 104 and the driving scanning section 105 of the vertical driving section 103 scan the pixel array section 102 in a unit of a row, and the horizontal driving section 106 writes an image signal into the pixel array section 102 simultaneously for one horizontal line in synchronism with the scanning.

The horizontal driving section 106 includes a driver circuit for simultaneously turning on switches not shown provided on the image signal lines of all columns. In particular, in order to simultaneously write an image signal inputted from the image signal processing section 300 into all of the pixel circuits P for one line of the selected row by the vertical driving section 103, the horizontal driving section 106 simultaneously turns on the switches not shown provided on the image signal lines 106HS of all columns so that the image signal Vsig (an example of a horizontal scanning signal) is supplied to the horizontal scanning lines (image signal lines 106HS) through the driver circuit.

The vertical driving section 103 includes a plurality of stages each formed from a combination of logic gates including a latch and a driver circuit. The vertical driving section 103 selects the pixel circuits P of the pixel array section 102 in a unit of a row by the logic gates and vertical scanning signals are supplied to the vertical scanning circuits through the driver circuit. It is to be noted that, while FIG. 1 shows the configuration wherein the vertical driving section 103 is disposed on only one side of the pixel array section 102, it is possible to adopt another configuration wherein the vertical driving section 103 is disposed on the opposite left and right sides across the pixel array section 102. Similarly, while FIG. 1 shows the configuration wherein the horizontal driving section 106 is disposed on only one side of the pixel array section 102, it is possible to adopt another configuration wherein the horizontal driving section 106 is disposed on the opposite upper and lower sides across the pixel array section 102.

As can be recognized from the connection scheme of the vertical driving section 103 (writing scanning section 104 and driving scanning section 105) or the horizontal driving section 106 and the vertical scanning lines (writing scanning lines 104WS and power supply lines 105DSL) or the horizontal scanning lines (image signal lines 106HS), scanning lines are demanded in order to supply a scanning signal to the pixel circuits P of the pixel array section 102. In a simple mechanism, as the number of pixel circuits P increases, also the number of scanning lines increases in a corresponding relationship, and also the number of driver circuits for driving the scanning lines increases. Although the organic EL display apparatus 1 is shown in the form wherein the scanning lines are disposed for the individual rows and the individual columns for the convenience of illustration, embodiments of the present invention hereinafter described adopt a mechanism wherein the number of scanning lines (particularly the image signal lines 106HS) is reduced while the number of pixels is maintained.

### PIXEL CIRCUIT OF A COMPARATIVE EXAMPLE: FIRST EXAMPLE

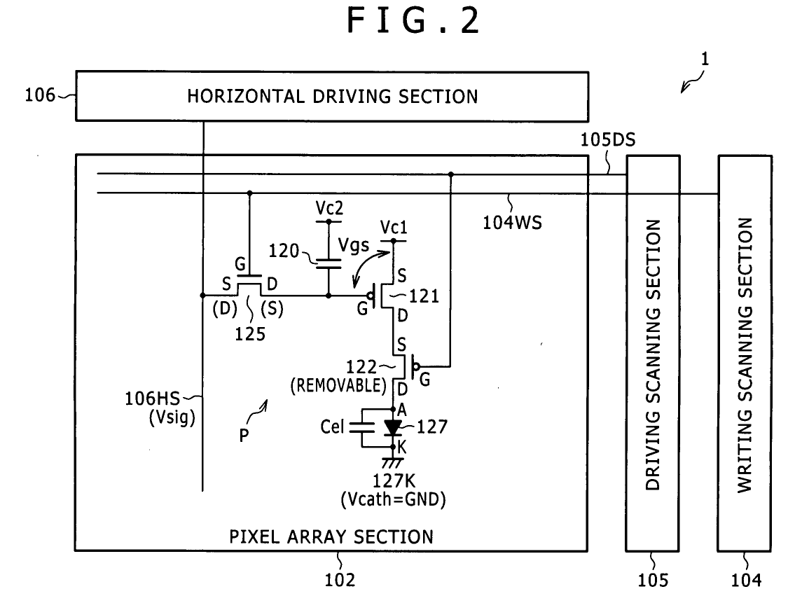

Referring to FIG. 2, there is shown a pixel circuit P according to a first comparative example. The pixel circuit P shown is that a drive transistor thereof is formed basically from a p-type thin film field effect transistor (TFT). Further, the pixel circuit P adopts a three-transistor driving configuration which includes two transistors for scanning in addition to the drive transistor.

In particular, the pixel circuit P of the first comparative example includes a p-type drive transistor 121, a p-type light emission controlling transistor 122 to which an active-L (low) driving pulse is supplied, an n-type sampling transistor 125 to which an active-H (high) driving pulse is supplied, an organic EL element 127 which is an example of an electro-optical element or light emitting element which emits light when current flows therethrough, and a storage capacitor 120. The storage capacitor 120 is hereinafter referred to also as pixel capacitor. It is to be noted that, as the simplest circuit configuration, the pixel circuit P may adopt a two-transistor driving configuration from which the light emission controlling transistor 122 is removed. In this instance, the organic EL display apparatus 1 has a configuration from which the driving scanning section 105 is removed.

The drive transistor 121 supplies driving current to the organic EL element 127 in response to a potential supplied to the gate terminal which is a control input terminal thereof. Since the organic EL element 127 usually has a rectification property, it is represented by a symbol of a diode. It is to be noted that the organic EL element 127 has parasitic capacitance Cel. In FIG. 2, the parasitic capacitance Cel is shown connected in parallel to the organic EL element 127.

The sampling transistor 125 is a switching transistor provided on the gate side or control input terminal side of the drive transistor 121, and also the light emission controlling transistor 122 is a switching transistor. It is to be noted that generally the sampling transistor 125 can be replaced by a p-type transistor to which an active-L driving pulse is supplied. Also the light emission controlling transistor 122 can be replaced by an n-type transistor to which an active-H driving pulse is supplied.

The pixel circuit P is disposed at an intersecting point between scanning lines 104WS and 105DS of the vertical scanning side and an image signal line 106HS which is a scanning line on the horizontal scanning side. The writing scanning line 104WS from the writing scanning section 104 is connected to the gate terminal of the sampling transistor 125, and the driving scanning line 105DS from the driving scanning section 105 is connected to the gate terminal of the light emission controlling transistor 122.

The sampling transistor 125 is connected at the source terminal S thereof, which serves as a signal input terminal, to the image signal line 106HS, and at the drain terminal D thereof, which serves as a signal output terminal, to the gate electrode G of the drive transistor 121. The storage capacitor 120 is provided between the node between the drain terminal D of the sampling transistor 125 and the gate electrode G of the drive transistor 121 and a second power supply potential Vc2 which is, for example, a positive power supply voltage and may be equal to a first power supply potential Vel. As indicated in parentheses in FIG. 2, the sampling transistor 125 may be connected in a reversed connection relationship regarding the source terminal S and the drain terminal D thereof such that it is connected at the drain terminal D thereof serving as a signal input terminal to the image signal line 106HS and at the source terminal S thereof serving as a signal output terminal to the gate electrode G of the drive transistor 121.

The drive transistor 121, light emission controlling transistor 122 and organic EL element 127 are connected in series in this order between the first power supply potential Vc1 such as, for example, a positive power supply and a ground potential GND which is an example of a reference potential. In particular, the drive transistor 121 is connected at the source terminal S thereof to the first power supply potential Vc1 and at the drain terminal D thereof to the source terminal S of the light emission controlling transistor 122. The light emission controlling transistor 122 is connected at the drain terminal D thereof to the anode terminal A of the organic EL element 127, and the organic EL element 127 is connected at the cathode terminal K thereof to a cathode common wiring line 127K common to the pixels. The cathode common wiring line 127K may be, for example, the ground potential GND. In this instance, also the cathode potential Vcath of the cathode common wiring line 127K is the ground potential GND.

In both of the 3-transistor driving system illustrated in FIG. 2 and the 2-transistor driving system not shown, a gradation of color development is obtained by controlling the amount of current to flow through the organic EL element 127 because the organic EL element 127 is a current light emitting element. Therefore, the application voltage to the gate terminal of the drive transistor 121 is varied to vary the gate-source voltage Vgs to be stored into the storage capacitor 120 thereby to control the amount of current to flow through the organic EL element 127. Thereupon, the potential of the image signal Vsig, that is, the image signal line potential, to be supplied from the image signal line 106HS is set to the signal potential. It is to be noted that the signal amplitude representing a gradation is represented by ΔVin.

IF an active-high writing driving pulse WS is supplied from the writing scanning section 104 to place the writing scanning line 104WS into a selected state and a signal potential is applied to the image signal line 106HS from the horizontal driving section 106, then the sampling transistor 125 conducts and the signal potential becomes the potential of the gate terminal of the drive transistor 121. Consequently, information corresponding to the signal amplitude ΔVin is written into the storage capacitor 120. The current flowing through the drive transistor 121 and the organic EL element 127 has a value corresponding to the gate-source voltage Vgs of the drive transistor 121 stored in the storage capacitor 120, and the organic EL element 127 continues to emit light with a luminance defined by the current value. The operation of selecting the writing scanning line 104WS so that the image signal Vsig applied to the image signal line 106HS is transmitted to the inside of the pixel circuit P is called “writing” or “sampling.” If writing of the signal is carried out once, then the organic EL element 127 continues to emit light with a fixed luminance for a period of time until the signal is rewritten subsequently.

In the pixel circuit P of the first comparative example, the application voltage to be applied to the gate terminal of the drive transistor 121 is varied in response to the signal amplitude ΔVin to control the value of current to flow through the organic EL element 127. At this time, the source terminal of the p-type drive transistor 121 is connected to the first power supply potential Vc1, and consequently, the drive transistor 121 normally operates in a saturation region.

### PIXEL CIRCUIT OF A COMPARATIVE EXAMPLE: SECOND EXAMPLE

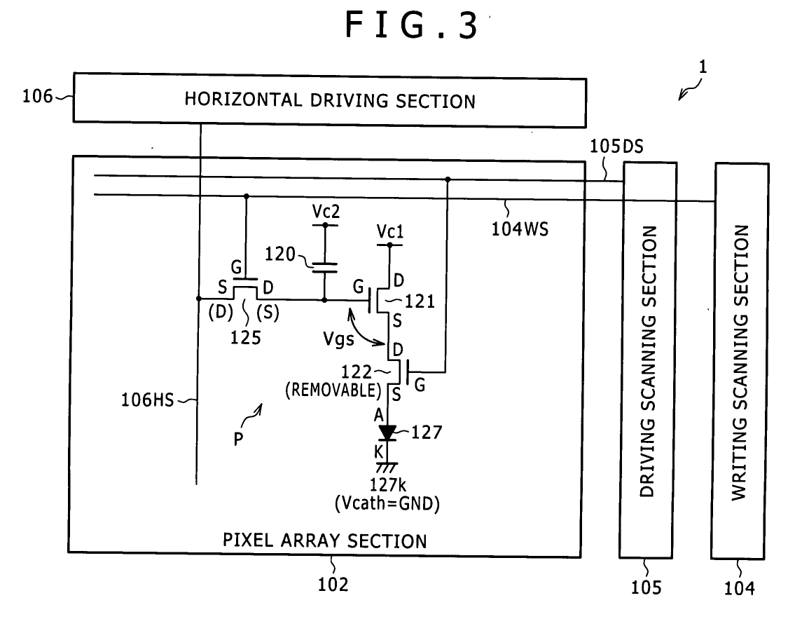

Now, a pixel circuit P of a second comparative example shown in FIG. 3 is described. Referring to FIG. 3, the pixel circuit P of the second comparative example is that a drive transistor is basically formed from an n-type thin film field effect transistor (this similarly applies also to the embodiments of the present invention hereinafter described). If not a p-type thin film field effect transistor but an n-type thin film field effect transistor can be formed, then it is possible to use an existing amorphous silicon (a-Si) process in transistor production. This can achieve the reduction cost of a transistor substrate, and therefore, a pixel circuit P of such a configuration as just described is expected.

The pixel circuit P of the second comparative example is common to that of the embodiments of the present invention hereinafter described in that a drive transistor is basically formed from an n-type thin film field effect transistor. However, the pixel circuit P of the second comparative example does not include a driving signal fixing circuit for preventing an influence of a characteristic fluctuation of the organic EL element 127 or the drive transistor 121 by dispersion or aged deterioration from being had on driving current Ids.

In particular, in the pixel circuit P of the second comparative example, the p-type drive transistor 121 of the pixel circuit P in the first comparative example is replaced by an n-type drive transistor 121 and a light emission controlling transistor 122 and a organic EL element 127 are disposed on the source terminal side of the n-type drive transistor 121. It is to be noted that also the light emission controlling transistor 122 is replaced by an n-type light emission controlling transistor 122. Naturally, the pixel circuit P may otherwise adopt a two-transistor driving configuration from which the light emission controlling transistor 122 is removed as the simplest circuit.

In the pixel circuit P of the second comparative example, irrespective of whether or not the light emission controlling transistor is provided, when the organic EL element 127 is to be driven, the drain terminal side of the drive transistor 121 is connected to the first power supply potential Vc1 and the source terminal side of the drive transistor 121 is connected to the anode terminal side of the organic EL element 127 so as to generally form a source follower circuit.

<Relationship with the Iel-Vel Characteristic of the Electro-Optical Element>

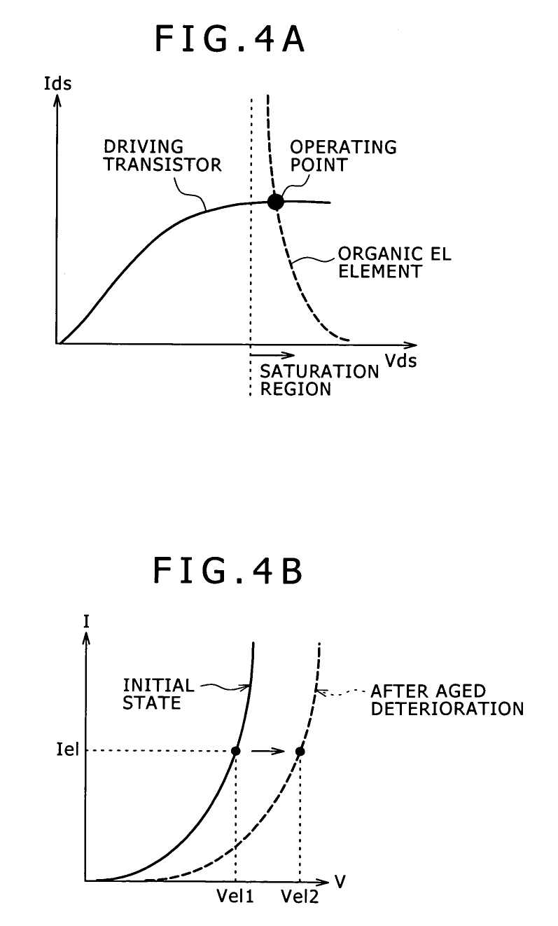

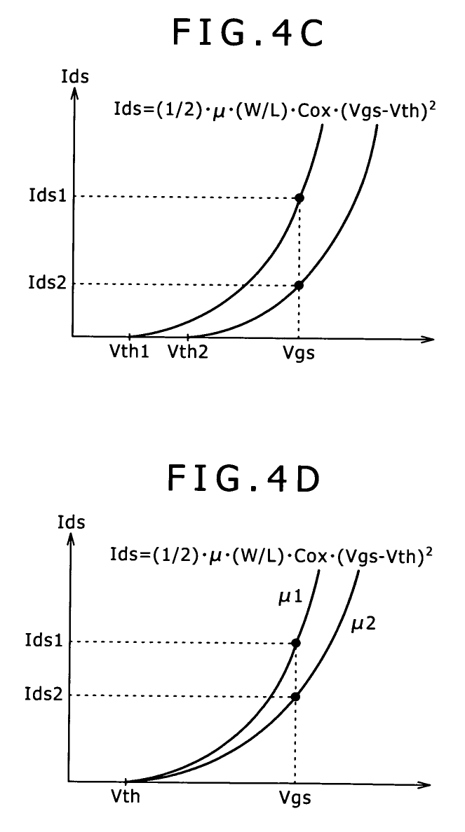

Generally, the drive transistor 121 is driven in a saturation region thereof wherein the driving current Ids is fixed irrespective of the drain-source voltage thereof as seen in FIG. 4A. Therefore, where the current flowing between the drain terminal and the source of a transistor which operates in a saturation region is represented by Ids, the mobility by μ, the channel width or gate width by W, the channel length or gate length by L, the gate capacitance, that is, the gate oxide film capacitance per unit area, by Cox and the threshold voltage of the transistor by Vth, the drive transistor 121 serves as a constant current source having a current value given by the equation (1) given below. It is to be noted that “̂” represents a power. As can be recognized from the equation (1), the driving current Ids of the transistor in its saturation region is controlled with the gate-source voltage Vgs and operates as a constant current source.

$$Ids = \frac{1}{2} μ \frac{W}{L} Cox ( Vgs - Vth ) \hat{} 2 \qquad ( 1 )$$

However, the I-V characteristic of a light emitting element of the current driving type beginning with an organic EL element generally varies as time passes as seen from FIG. 4B. In the current-voltage (Iel-Vel) characteristic of the light emitting element of the current driven type represented by an organic EL element illustrated in FIG. 4B, a solid line curve indicates a characteristic in an initial state, and a broken line curve indicates a characteristic after aged deterioration.

For example, when light emitting current Iel flows through the organic EL element 127 which is an example of a light emitting element, the first power supply potential Vel is determined uniquely. However, as seen in FIG. 4B, within a light emitting period, the light emitting current Iel which is determined by the driving current Ids, equal to the driving current Ids, of the drive transistor 121 flows to the anode terminal of the organic EL element 127, and the potential at the anode terminal of the organic EL element 127 rises by an amount corresponding to the anode-cathode voltage Vel of the organic EL element 127.

While, in the pixel circuit P of the first comparative example shown in FIG. 2, an influence of rise by the anode-cathode voltage Vel of the organic EL element 127 appears on the drain terminal side of the drive transistor 121, since the drive transistor 121 is driven by constant current driving wherein it operates in its saturation region, the driving current Ids continues to flow through the organic EL element 127. Thus, even if the Iel-Vel characteristic of the organic EL element 127 varies, the emitted light luminance of the organic EL element 127 does not undergo aged deterioration.

Referring to FIG. 3, the pixel circuit P of the second comparative example includes the drive transistor 121, light emission controlling transistor 122, storage capacitor 120 and sampling transistor 125 and is configured such that the configuration of the pixel circuit P having the connection scheme shown in FIG. 2 forms a driving signal fixing circuit which compensates for the variation of the current-voltage characteristic of the organic EL element 127, which is an example of an electro-optical element, to keep the driving current fixed. In particular, since the p-type drive transistor 121 is designed such that, when the pixel circuit P is driven with the image signal Vsig, the source terminal thereof is connected to the first power supply potential Vc1 such that the drive transistor 121 always operates in the saturation region, it serves as a constant current source which supplies current of a value defined by the equation (1) given hereinabove.

Further, in the pixel circuit P of the first comparative example, the voltage at the drain terminal of the drive transistor 121 varies together with the aged deterioration (FIG. 4B) of the Iel-Vel characteristic of the organic EL element 127. However, since the gate-source voltage Vgs is kept fixed in principle by the bootstrap function of the storage capacitor 120, the drive transistor 121 operate as a constant current source. As a result, a fixed amount of current flows to the organic EL element 127, and the organic EL element 127 can emit light with a fixed luminance. Consequently, the luminance of emitted light of the organic EL element 127 does not vary.

Also in the pixel circuit P of the second comparative example, the potential of the source terminal of the drive transistor 121, that is, the source potential Vs, depends upon the operating point between the drive transistor 121 and the organic EL element 127, and the drive transistor 121 operates in the saturation region. Therefore, the driving current Ids of the current value defined by the equation (1) given hereinabove flows with the gate-source voltage Vgs corresponding to the source voltage of the operating point.

However, in the simple circuit wherein the p-type drive transistor 121 of the pixel circuit P of the first comparative example is replaced by the n-type drive transistor 121, that is, in the pixel circuit P of the second comparative example, the source terminal of the drive transistor 121 is connected to the organic EL element 127 side. As a result, since the first power supply potential Vel with respect to the light emitting current Iel varies from a value Vel1 to another value Vel2 in accordance with the Iel-Vel characteristic of the organic EL element 127 which undergoes aged deterioration as illustrated in FIG. 4B, the operating point of the drive transistor 121 varies. Consequently, even if the same gate voltage Vg is applied, the source potential Vs of the drive transistor 121 varies. As a result, the gate-source voltage Vgs varies. As can be apparently recognized from the characteristic equation (1), if the gate-source voltage Vgs fluctuates, then even if the gate voltage Vg is fixed, then the driving current Ids fluctuates. The fluctuation of the driving current Ids by this cause appears as dispersion of the emitted light luminance among the pixel circuits P or aged deterioration of the pixel circuits P.

In contrast, although details are hereinafter described, also where the n-type drive transistor 121 is used, if a circuit configuration and a driving timing with which the bootstrap function of interlocking the gate voltage Vg of the gate terminal of the drive transistor 121 with the variation of the source potential Vs of the source terminal of the drive transistor 121, then even if the anode potential of the organic EL element 127 is fluctuated, that is, even if the source potential of the drive transistor 121 is fluctuated, by the aged deterioration of the characteristic of the organic EL element 127, the gate voltage Vg can be varied so as cancel the fluctuation. Consequently, the uniformity of the screen image luminance can be assured. Thus, the aged deterioration correction capacity of the light emitting element of the current driven type represented by an organic EL element can be improved by the bootstrap function. Naturally, the bootstrap function operates also when the source potential Vs of the drive transistor 121 varies in response to the fluctuation of the anode-cathode voltage Vel in a process after the light emitting current Iel begins to flow through the organic EL element 127 at a point of time at which emission of light is started until the anode-cathode voltage Vel rises until it is stabilized.

<Relationship with the Vgs-Ids Characteristic of the Driving Transistor>

Further, although characteristics of the drive transistor 121 are not regarded as a question in the first and second comparative examples, if a characteristic of the drive transistor 121 differs among different pixels, then this has an influence on the driving current Ids flowing through the drive transistor 121. As an example, as can be recognized from the equation (1), where the mobility μ or the threshold voltage Vth disperses among different pixels or suffers from aged deterioration, even if the gate-source voltage Vgs is equal, the driving current Ids flowing through the drive transistor 121 undergoes dispersion or aged deterioration. Therefore, also the luminance of emitted light of the organic EL element 127 varies among different pixels.

For example, dispersion of the fabrication process of the drive transistor 121 gives rise to characteristic dispersion of the threshold voltage Vth and the mobility μ among different pixel circuits P. Also where the drive transistor 121 is driven in its saturation region, even if the same gate voltage is applied to the drive transistor 121, the drain current, that is, the driving current Ids, is fluctuated among different pixel circuits P by the characteristic fluctuation, resulting in appearance as dispersion of the luminance of emitted light.

As described hereinabove, the driving current Ids when the drive transistor 121 operates in the saturation region is represented by the characteristic equation (1). Where attention is paid to the threshold voltage dispersion of the drive transistor 121, as can be recognized apparently from the characteristic equation (1), if the threshold voltage Vth fluctuates, then even if the gate-source voltage Vgs is fixed, the driving current Ids fluctuates. On the other hand, if attention is paid to the mobility dispersion of the drive transistor 121, then as can be recognized apparently from the characteristic equation (1), if the mobility μ fluctuates, then even if the gate-source voltage Vgs is fixed, the driving current Ids fluctuates.

In this manner, if a great difference appears in the Vgs-Ids characteristic due to a difference in the threshold voltage Vth or the mobility μ, then even if the same signal amplitude ΔVin is applied, the driving current Ids fluctuates, resulting in difference of the luminance of emitted light. Therefore, the uniformity of the luminance of emitted light is not obtained. In contrast, where a driving timing hereinafter described in detail is set such that the threshold value correction function and the mobility correction function are implemented, the influence of the fluctuations can be suppressed and the uniformity of the emitted light luminance can be assured.

In the threshold value correction operation and the mobility correction operation adopted by the embodiment of the present invention, if it is assumed that the write gain is 1 which is an ideal value, then the gate-source voltage Vgs of the drive transistor 121 is set so as not to rely upon the dispersion or the fluctuation of the threshold voltage Vth and so as not to rely upon the dispersion or the fluctuation of the mobility μ. As a result, even if the threshold voltage Vth or the mobility μ is fluctuated by the fabrication process or aged deterioration, the driving current Ids does not fluctuate and the emitted light luminance of the organic EL element 127 does not fluctuate either. Upon mobility correction, negative feedback is applied so that the mobility correction parameter ΔV1 has a high value for a high mobility μ1 whereas the mobility correction parameter ΔV2 has a low value for a low mobility μ2. From this, these mobility correction parameter ΔV is referred to also as negative feedback amount ΔV.

### PIXEL CIRCUIT OF A COMPARATIVE EXAMPLE: THIRD EXAMPLE

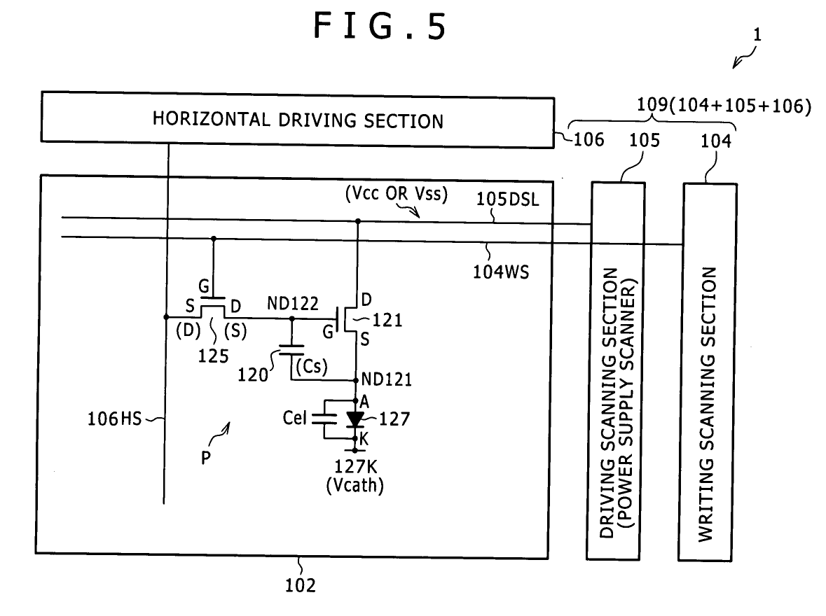

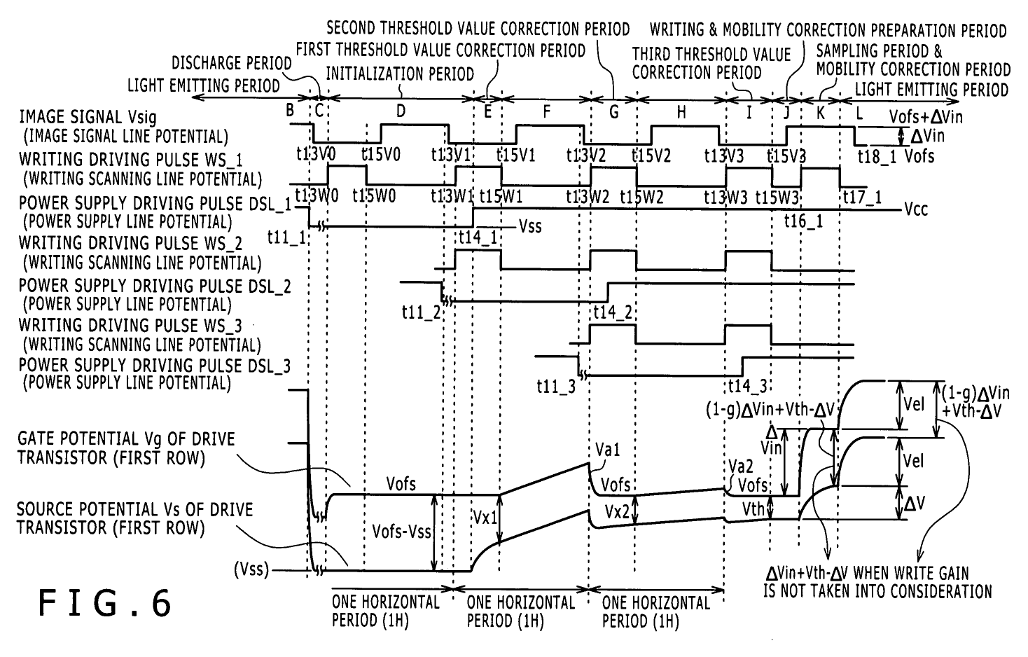

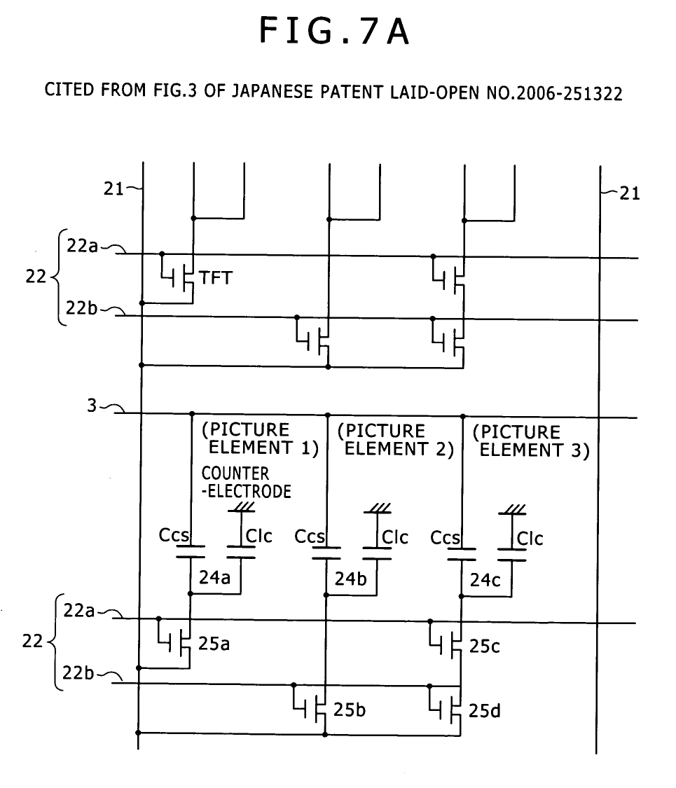

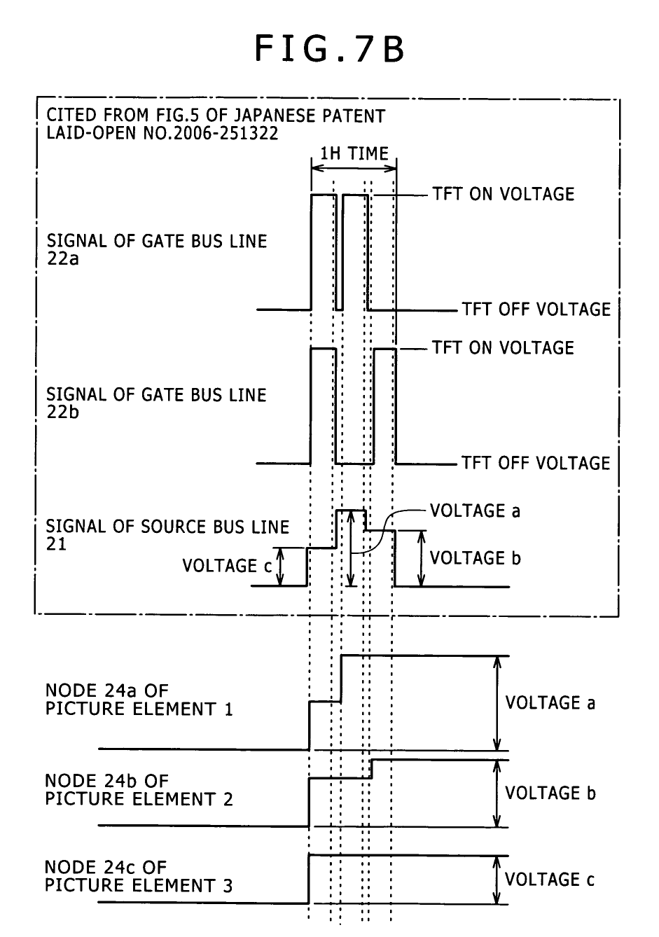

A pixel circuit P of a third comparative example is shown in FIG. 5. The pixel circuit P of the third comparative example incorporates a circuit, that is, a bootstrap circuit, for preventing fluctuation of the driving current by the aged deterioration of the organic EL element 127 in the pixel circuit P of the second comparative example shown in FIG. 3. Further, the pixel circuit P of the third comparative example adopts a driving method for preventing driving current fluctuation by a fluctuation of a characteristic such as threshold voltage dispersion or mobility dispersion of the drive transistor 121. The pixel circuit P according to the embodiments of the present invention hereinafter described is based also on the pixel circuit P of the third comparative example.

The pixel circuit P of the third comparative example uses an n-type drive transistor 121 similarly to the pixel circuit P of the second comparative example. In addition, the pixel circuit P of the third comparative example includes a circuit for suppressing the fluctuation of the driving current Ids to an organic EL element by aged deterioration of the organic EL element and a driving signal fixing circuit for compensating for the variation of the current-voltage characteristic of the organic EL element, which is an example of an electro-optical element, to keep the driving current Ids fixed. The pixel circuit P of the third comparative example has a function of fixing the driving current even where the current-voltage characteristic of the organic EL element suffers from aged deterioration.

In particular, the pixel circuit P of the third comparative example further adopts a two-transistor driving configuration which uses a switching transistor for scanning, that is, a sampling transistor 125, in addition to the drive transistor 121. The pixel circuit P of the third comparative example further prevents aged deterioration of the organic EL element 127 or fluctuation of a characteristic of the drive transistor 121 such as, for example, dispersion or fluctuation of the threshold voltage or the mobility from having an influence on the driving current Ids by setting of on/off timings or switching timings of the power supply driving pulse DSL and the writing driving pulse WS for controlling the switching transistors. Since the pixel circuit P of the third comparative example has a two-transistor driving configuration and includes a comparatively small number of pixels or wiring lines, enhancement of the definition can be anticipated.

The significant difference in configuration of the pixel circuit P of the third comparative example from the pixel circuit P of the second comparative example of FIG. 3 resides in that the connection scheme of the storage capacitor 120 is modified so that a bootstrap circuit which is an example of a driving signal fixing circuit is formed as a circuit for preventing driving current fluctuation by aged deterioration of the organic EL element 127. As a method of suppressing the influence of the fluctuation of a characteristic of the drive transistor 121 such as, for example, dispersion or fluctuation of the threshold voltage or the mobility on the driving current Ids, the driving timings of the transistors 121 and 125 are devised.

In particular, the pixel circuit P of the third comparative example includes a storage capacitor 120, an n-type drive transistor 121, an n-type sampling transistor 125 to which an active-high writing driving pulse WS is supplied, and an organic EL element 127 which is an example of an electro-optical element or light emitting element when current flows therethrough.

The storage capacitor 120 is connected between the gate terminal or node ND122 and the source terminal of the drive transistor 121, and the source terminal of the drive transistor 121 is directly connected to the anode terminal of the organic EL element 127. The storage capacitor 120 functions as a bootstrap capacitor. The organic EL element 127 is connected at the cathode electrode thereof to a cathode common wiring line 127K common to all pixels similarly as in the first or second comparative example, and a cathode potential Vcath such as for example, the ground potential GND, is applied to the cathode electrode of the organic EL element 127.

The drive transistor 121 is connected at the drain terminal thereof to a power supply line 105DSL from the driving scanning section 105 which functions as a power supply scanner. The power supply line 105DSL itself provides a power supplying function to the drive transistor 121.

In particular, the driving scanning section 105 includes a power supply voltage changeover circuit for changing over the potential to be supplied to the drain terminal of the drive transistor 121 between a first potential Vcc of the high voltage side and a second potential Vss of the low voltage side which individually correspond to power supply voltages.

The second potential Vss is set to a potential sufficiently lower than an offset potential Vofs, also referred to as reference potential, of the image signal Vsig of the image signal line 106HS. In particular, the second potential Vss of the low potential side of the power supply line 105DSL is set so that the gate-source voltage Vgs of the drive transistor 121, that is, the difference between the gate voltage Vg and the source potential Vs, may be higher than the threshold voltage Vth of the drive transistor 121. It is to be noted that the offset potential Vofs is utilized for an initialization operation preceding to a threshold value correction operation and also for precharging the image signal line 106HS in advance.

The sampling transistor 125 is connected at the gate terminal thereof to the writing scanning line 104WS from the writing scanning section 104, at the drain terminal thereof to the image signal line 106HS and at the source terminal thereof to the gate terminal of the drive transistor 121, that is, to the node ND122. An active-high writing driving pulse WS is supplied to the gate terminal of the drive transistor 121 from the writing scanning section 104.

The sampling transistor 125 can be connected also in a different connection scheme wherein the source terminal and the drain terminal thereof are reversed. Further, any of a depression type transistor and an enhancement type transistor can be used for the sampling transistor 125.

### OPERATION OF THE PIXEL CIRCUIT: THIRD COMPARATIVE EXAMPLE

FIG. 6 illustrates a basic example of driving timings of the third comparative example of the pixel circuit P according to the third comparative example shown in FIG. 5, particularly in the case of line-sequential driving. In FIG. 6, a potential variation of the writing scanning line 104WS, a potential variation of the power supply line 105DSL and a potential variation of the image signal line 106HS are represented on the common time axis. Further, in parallel to the potential variations, also variations of the gate voltage Vg and the source potential Vs of the drive transistor 121 for one row, in the example illustrated, for the first row, are illustrated.

The driving timings illustrated in FIG. 6 are those in the case of line-sequential driving, and the timings of the writing driving pulse WS, power supply driving pulse DSL and image signal Vsig make a group for one row and are controlled, particularly in the phase relationship among the signals, independently of each other. When the row changes, the signals are shifted by 1H where H is a horizontal scanning period.

In the following, in order to facilitate description and understandings, unless otherwise specified, it is assumed that the write gain is 1 which is an ideal value, such a simple description as to write, store or sample information of the signal amplitude ΔVin into the storage capacitor 120 is used. Where the write gain is lower than 1, not information of the magnitude itself of the signal amplitude ΔVin but information of the signal amplitude ΔVin multiplied by a corresponding gain is stored into the storage capacitor 120.

Incidentally, the ratio of the magnitude of the information written into the storage capacitor 120 to the signal amplitude ΔVin is referred to as write gain Ginput. Here, the write gain Ginput relates to an amount of charge distributed to the total capacitance C1 of a capacitance series circuit, which includes the total capacitance C1 including parasitic capacitance connected in parallel to the storage capacitor 120 in an electric circuit and total capacitance C2 disposed in series to the storage capacitor 120 in an electric circuit, when the signal amplitude ΔVin is supplied to the capacitance series circuit. If this is represented by an equation, then the write gain Ginput=C2/(C1+C2)=1−C1/(C1+C2)=1−g where g=C1/(C1+C2). In the following description, any description which includes “g” takes the write gain into consideration.

Further, in order to facilitate description and understandings, unless otherwise specified, it is assumed that the bootstrap gain is 1 of an ideal value to give simplified description. Incidentally, where the storage capacitor 120 is provided between the gate and the source of the drive transistor 121, the rising ratio of the gate voltage Vg to the rise of the source potential Vs is referred to as bootstrap gain Gbst (bootstrap operation capacity). The bootstrap gain Gbst here relates particularly to the capacitance value Cs of the storage capacitor 120, the capacitance value Cgs of parasitic capacitance C121gs formed between the gate and the source of the drive transistor 121, the capacitance value Cgd of parasitic capacitance C121gd formed between the gate and the drain of the drive transistor 121 and the capacitance value Cws of parasitic capacitance C125gs formed between the gate and the source of the sampling transistor 125. If this is represented by an equation, then the bootstrap gain Gbst=(Cs+Cgs)/(Cs+Cgs+Cgd+Cws).

Further, in the driving timings of the third comparative example, a period within which the image signal Vsig has the offset potential Vofs which provides an ineffective period is referred to as a front half of one horizontal period, and a period within which the image signal Vsig has the signal potential Vin (=Vofs+ΔVin) which provides an effective period is referred to as a rear half of the one horizontal period. Further, for every one horizontal period which includes an effective period and an ineffective period of the image signal Vsig, a threshold value correction operation is repeated by a plural number of times, in the operation of FIG. 6, three times. The changeover timings (t13V and t15V) between the effective period and the ineffective period of the image signal Vsig and the changeover timings (t13W and t15W) between the active and inactive stages of the writing driving pulse WS are distinguished from each other by indicating the timings with a reference character applied thereto without the quotation marks “_” for each operation cycle.

First, within a light emitting period B of the organic EL element 127, the power supply line 105DSL has the first potential Vcc and the sampling transistor 125 is in an off state. At this time, since the drive transistor 121 is set so as to operate in its saturation region, the driving current Ids flowing through the organic EL element 127 assumes a value indicated by the equation (1) in response to the gate-source voltage Vgs of the drive transistor 121.

Then, if a no-light emitting period is entered, then within a discharge period C, the potential of the power supply line 105DSL is changed over to the second potential Vss. At this time, when the second potential Vss is lower than the sum of the threshold voltage VthEL and the cathode potential Vcath of the organic EL element 127, that is, if “Vss<VthEL+Vcath,” then the organic EL element 127 stops the emission of light, and the power supply line 105DSL becomes the source side of the drive transistor 121. At this time, the anode of the organic EL element 127 is charged to the second potential Vss.

Further, within an initialization period D, when the potential of the image signal line 106HS becomes the offset potential Vofs, the sampling transistor 125 is turned on to set the gate potential of the drive transistor 121 to the offset potential Vofs. At this time, the gate-source voltage Vgs of the drive transistor 121 assumes the value of “Vofs−Vss.” Since the threshold value correction operation cannot be carried out if the value “Vofs−Vss” is not higher than the threshold voltage Vth of the drive transistor 121, there is the necessity to establish the relationship of “Vofs−Vss>Vth.”

Thereafter, when a first threshold value correction period E is entered, the potential of the power supply line 105DSL is changed over back to the first potential Vcc. As the power supply line 105DSL, that is, the power supply voltage to the drive transistor 121, is set to the first potential Vcc, the anode of the organic EL element 127 serves as the source of the drive transistor 121 and the driving current Ids flows from the drive transistor 121. Since the equivalent circuit of the organic EL element 127 is represented by a diode and a capacitor, where the anode voltage of the organic EL element 127 with respect to the cathode potential Vcath is represented by Vel, as far as “Vel≦Vcath+VthEL” is satisfied, the driving current Ids of the drive transistor 121 is used to charge the storage capacitor 120 and the parasitic capacitance Cel of the organic EL element 127. At this time, the first power supply potential Vel of the organic EL element 127 rises as time passes.

After a fixed period of time passes, the sampling transistor 125 is turned off. At this time, if the gate-source voltage Vgs of the drive transistor 121 is higher than the threshold voltage Vth, that is, if the threshold value correction is not completed as yet, then the driving current Ids of the drive transistor 121 continues to flow so as to charge the storage capacitor 120, and the gate-source voltage Vgs of the drive transistor 121 rises. At this time, since the organic EL element 127 is in a state wherein it is biased reversely, the organic EL element 127 does not emit light at all.

Further, if a second threshold value correction period G is entered, then when the potential of the image signal line 106HS becomes the offset potential Vofs, the sampling transistor 125 is turned on so that the gate potential of the drive transistor 121 becomes equal to the offset potential Vofs to start a threshold value correction operation again. This operation is repeated until the gate-source voltage Vgs of the drive transistor 121 finally assumes the threshold voltage Vth. At this time, the state of “Vel=Vofs−Vth≦Vcath+VthEL” is satisfied.

It is to be noted that, in the operation example of the present third comparative example, in order to cause a voltage corresponding to the threshold voltage Vth of the drive transistor 121 to be stored into the storage capacitor 120 with certainty by repetitively executing the threshold value correction operation, one horizontal period is determined as a processing cycle to repeat the threshold value correction operation by a plural number of times. However, this repetition operation is not necessarily demanded, but the threshold value correction operation may be executed only once determining one horizontal period as a processing circuit.

After the threshold value operation ends, in the example illustrated in FIG. 6, after a third threshold value correction period I, the sampling transistor 125 is turned off to enter a writing and mobility correction preparation period J. When the image signal line 106HS becomes equal to the signal potential Vin (=Vofs+ΔVin), the sampling transistor 125 is turned on again to enter a sampling period and mobility correction period K. The signal amplitude ΔVin has a value corresponding to a gradation. Since the sampling transistor 125 is on, the gate potential of the sampling transistor 125 is the signal amplitude ΔVin (=Vofs+ΔVin). However, since the drain terminal of the drive transistor 121 has the first potential Vcc and the driving current Ids flows, the source potential Vs rises as time passes. In FIG. 6, the rising amount is represented by ΔV.

At this time, if the source potential Vs does not exceed the sum of the threshold voltage VthEL and the cathode potential Vcath of the organic EL element 127, or in other words, if the leak current of the organic EL element 127 is considerably lower than the current flowing through the drive transistor 121, then the driving current Ids of the drive transistor 121 is used to charge the storage capacitor 120 and the parasitic capacitance Cel of the organic EL element 127.

At this point of time, since the threshold value correction operation of the drive transistor 121 is completed already, the current which is supplied from the drive transistor 121 reflects the mobility μ. In particular, if the mobility μ is high, then the current amount at this time is great and also the source voltage rises quickly. On the contrary, if the mobility μ is low, the current amount is small and the source potential rises slowly. Consequently, the gate-source voltage Vgs of the drive transistor 121 decreases reflecting the mobility μ, and after lapse of a fixed period of time, the gate-source voltage Vgs fully becomes equal to a voltage for correcting the mobility μ.

Thereafter, a light emitting period L is entered, and the sampling transistor 125 is turned off to end the writing and the organic EL element 127 is driven to emit light. Since the gate-source voltage Vgs of the drive transistor 121 is fixed by the bootstrap effect by the storage capacitor 120, the drive transistor 121 supplies fixed current, that is, the driving current Ids, to the organic EL element 127. Consequently, the first power supply potential Vel of the organic EL element 127 rises to a voltage Vx with which current equal to the driving current Ids flows to the organic EL element 127, and the organic EL element 127 emits light.

Also in the pixel circuit P of the third comparative example, as the light emission time of the organic EL element 127 becomes long, the I-V characteristic of the organic EL element 127 varies. Therefore, also the potential of the drive transistor 121, that is, the source potential Vs of the drive transistor 121, varies. However, since the gate-source voltage Vgs of the drive transistor 121 is kept to a fixed value by the bootstrap effect of the storage capacitor 120, the current flowing through the organic EL element 127 does not vary. Therefore, even if the I-V characteristic of the organic EL element 127 deteriorates, the fixed current, that is, the driving current Ids, continues to flow through the organic EL element 127, and the luminance of the organic EL element 127 does not vary.

Here, the relationship between the driving current Ids and the gate-source voltage Vgs can be represented by an equation (2-1) by substituting “ΔVin−ΔV+Vth” into Vgs of the equation (1) given hereinabove which represents the transistor characteristic. Incidentally, where the write gain is taken into consideration, the relationship can be represented by an equation (2-2) by substituting “(1−g)ΔVin−ΔV+Vth” into Vgs of the equation (1). In the equations (2-1) and (2-2) (collectively referred to as equations (2)), k=(½)(W/L)Cox.

$$\begin{matrix}Ids = k μ ( Vgs - Vth ) \hat{} 2 = k μ ( Δ Vin - Δ V ) \hat{} 2 & ( 2 - 1 ) \\ Ids = k μ ( Vgs - Vth ) \hat{} 2 = k μ ( ( 1 - g ) Δ Vin - Δ V ) \hat{} 2 & ( 2 - 2 )\end{matrix} \} \qquad ( 2 )$$

From the equations (2), it can be recognized that the term of the threshold voltage Vth is canceled and the driving current Ids supplied to the organic EL element 127 does not rely upon the threshold voltage Vth of the drive transistor 121. Basically, the driving current Ids depends upon the signal amplitude ΔVin=Vgs stored in the storage capacitor 120 corresponding to the signal amplitude ΔVin. In other words, the organic EL element 127 emits light with a luminance corresponding to the signal amplitude ΔVin.

Thereupon, the information stored into the storage capacitor 120 is in a state wherein it is corrected with the rise amount ΔV of the source potential Vs. The rise amount ΔV acts so as to cancel the effect of the mobility μ positioned at the coefficient part of the equation (2). While the correction amount ΔV for the mobility μ of the drive transistor 121 is added to the signal to be written into the storage capacitor 120, the direction of the addition actually is the negative direction. In this significance, the rise amount ΔV is referred to also as mobility correction parameter ΔV or negative feedback amount ΔV.

The driving current Ids flowing through the organic EL element 127 relies substantially only on the signal amplitude ΔVin because the fluctuation of the threshold voltage Vth or the mobility μ of the drive transistor 121 is canceled. Since the driving current Ids does not rely upon the threshold voltage Vth or the mobility μ, even if the threshold voltage Vth or the mobility μ is dispersed by the fabrication process or suffers from aged deterioration, the driving current Ids between the drain and the source of the drive transistor 121 does not fluctuate and the emitted light luminance of the organic EL element 127 does not fluctuate either Further, the storage capacitor 120 is connected between the gate and the source of the drive transistor 121 to achieve, also where the drive transistor 121 is of the n type, a circuit configuration and driving timings which implement a bootstrap function of causing the gate voltage Vg of the gate terminal of the drive transistor 121 to vary in an interlocking relationship with the fluctuation of the source potential Vs of the source terminal of the drive transistor 121. Thus, even if the anode potential of the organic EL element 127 is fluctuated by the aged deterioration of the characteristic of the organic EL element 127, that is, even if the source potential of the drive transistor 121 is fluctuated, the gate voltage Vg can be varied so as to cancel the fluctuation.

Consequently, the influence of the aged deterioration of the characteristics of the organic EL element 127 is moderated and the uniformity of the emitted light luminance can be assured. By the bootstrap function of the storage capacitor 120 between the gate and the source of the drive transistor 121, the aged deterioration correction function of the light emitting element of the current driven type represented by an organic EL element can be improved. Naturally, the bootstrap function operates also when the source potential Vs of the drive transistor 121 is fluctuated by the fluctuation of the anode-cathode voltage Vel of the organic EL element 127 in the process wherein the light emitting current Iel begins to flow through the organic EL element 127 at a point of time at which light emission is started and the anode-cathode voltage Vel of the organic EL element 127 rises until it is stabilized.

In this manner, according to the pixel circuit P of the third comparative example (and also according to the pixel circuit P in the embodiment of the present invention) and the driving timings by the control section 109 for driving the pixel circuit P, even when the drive transistor 121 or the organic EL element 127 suffers from a characteristic fluctuation such as characteristic dispersion or aged deterioration, the fluctuation amount is compensated for. Consequently, an influence of the fluctuation does not appear on the display screen image, and an image of high quality having no luminance variation can be displayed.

Incidentally, in order to allow the threshold value correction function, signal writing function, mobility correction function and bootstrap function to operate, it is necessary to carry out switching control of signals to the various transistors. For example, in order to control the pixel circuit P of the third comparative example shown in FIG. 5 to operate at such driving timings as illustrated in FIG. 6, it is necessary to carry out on/off control of the sampling transistor 125, switching control of the power supply to the drive transistor 121 between the first potential Vcc and the second potential Vss and switching control of the image signal Vsig between the offset potential Vofs and the signal potential Vin (=Vofs+ΔVin). In order to supply such signals to the pixel circuits P of the pixel array section 102, scanning lines are demanded, and as the number of pixel circuits P increases, also the number of scanning lines increases accordingly. From this point of view, a mechanism for reducing the number of scanning lines while maintaining the number of pixels is demanded.

If it is intended to reduce the cost based on the pixel circuit P of the third comparative example described above, it seems a possible idea first to reduce the number of scanning lines led out from the control section 109 (writing scanning section 104, driving scanning section 105 and horizontal driving section 106) provided around the pixel array section 102 without reducing the number of pixels. If the number of scanning lines is reduced, then the cost can be reduced by a circuit cost for driving the scanning lines.

### COMPARATIVE EXAMPLE: FOURTH EXAMPLE

FIG. 7A shows a reference circuit for a pixel circuit P used to form the organic EL display apparatus 1 shown in FIG. 1. Meanwhile, FIG. 7B illustrates driving timings where the mechanism of the reference circuit is applied to the pixel circuit P of the third comparative example (hereinafter referred to as fourth comparative example). It is to be noted that, in FIG. 7A, an arrangement of three pixels in one row and three columns is shown. The fourth comparative example is one form which is configured taking reduction in cost into consideration. Incidentally, part of FIGS. 7A and 7B is cited from the FIGS. 3 and 5 of Patent Document 2, and also reference characters of them are applied as they are.

If it is tried to reduce the number of scanning lines to achieve reduction of the cost, then where attention is paid to the horizontal driving section 106 side, it seems a possible idea to use an image signal line 106HS commonly to a plurality of pixels. In this instance, a liquid crystal display apparatus may adopt a mechanism for achieving reduction of the cost by using a signal line commonly among a plurality of pixels. For example, the mechanism disclosed in Patent Document 2 may be adopted.

However, since the mechanism disclosed in Patent Document 2 is configured such that a signal line is used commonly by adjacent pixels such that two image signals are inputted to one pixel to rewrite an image signal, this is an effective countermeasure for a system which does not carry out signal writing while current is supplied. However, the mechanism cannot be adopted simply in the third comparative example wherein, when an electro-optical element of the current driven time is to be driven, signal writing is carried out while current is supplied to carry out mobility correction.

This is because, if the image signal Vsig is inputted twice or more to the gate of the drive transistor 121 as shown in FIG. 7B, then mobility correction is carried out for the first image signal Vsig and the mobility correction operation cannot be carried out normally for the image signal Vsig which is inputted to the drive transistor 121 for the second time and so forth. Thererfore, it is difficult to commonly use the video signal 106HS, that is a problem in the view of reduction in cost.

Therefore, the embodiments of the present invention adopt a mechanism which carries out, when an image signal line 106HS is commonly used to a plurality of pixels paying attention to the horizontal driving section 106 side in an application to an electro-optical element of the current driven type, signal writing while current is supplied to carry out mobility correction. In the following, the mechanism is described.

### Improving Technique: First Embodiment

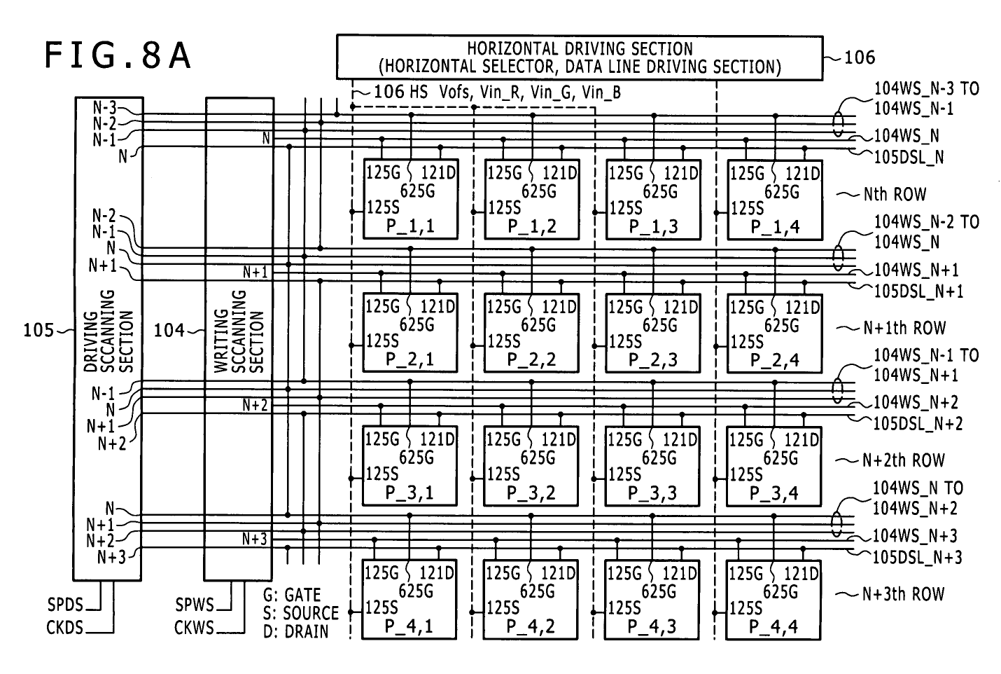

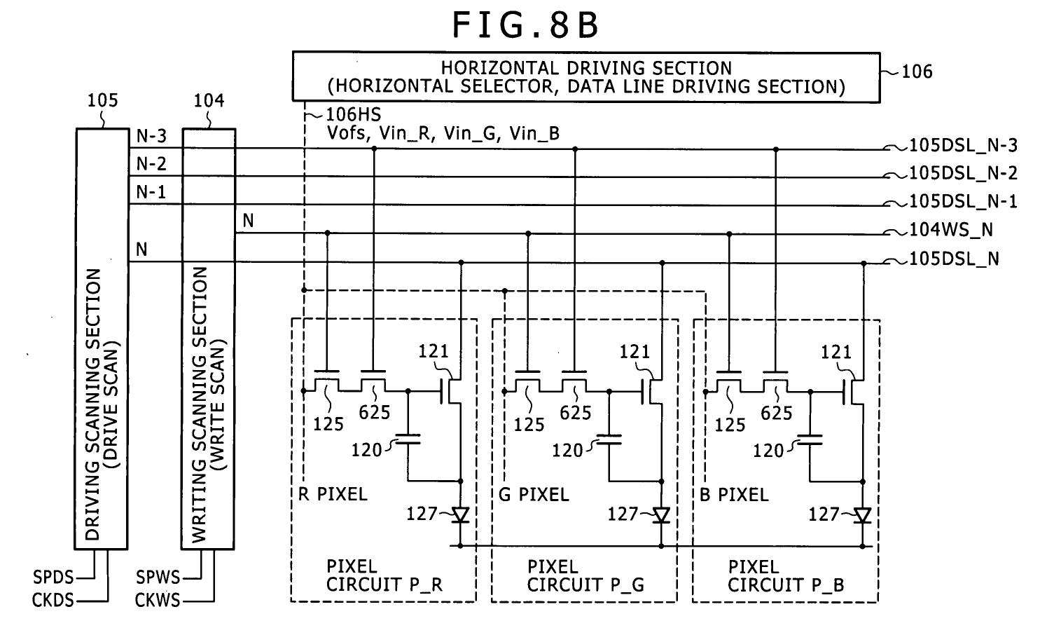

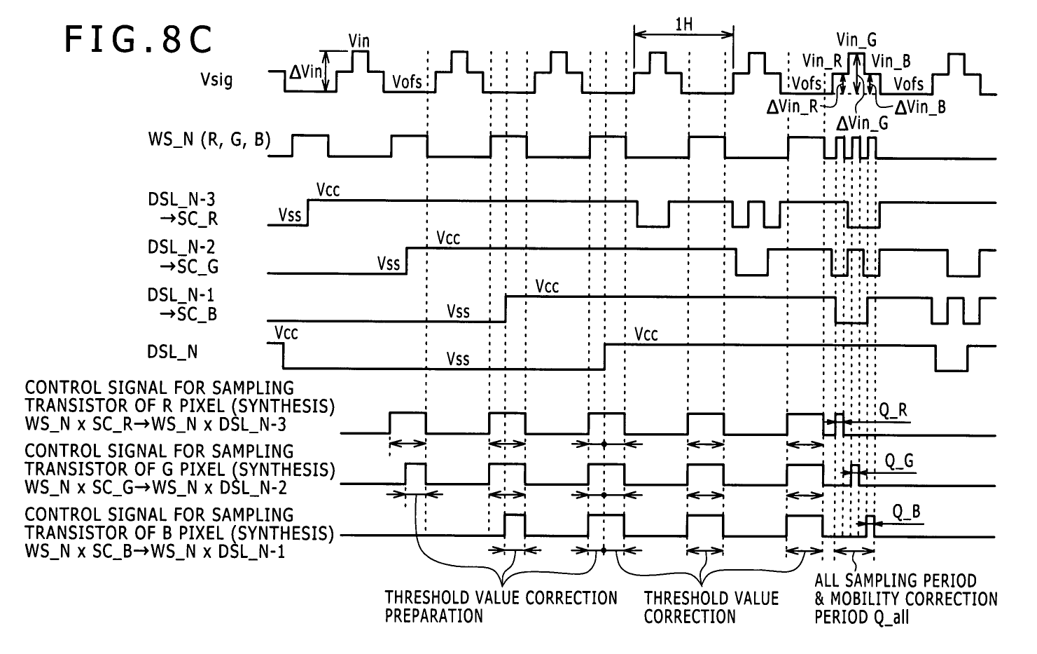

FIGS. 8A to 8C show an organic EL display apparatus according to a first embodiment of the present invention which adopts a system for carrying out signal writing while supplying current when the organic EL element 127, which is an example of an electro-optical element of the current driven type, to carry out mobility correction and wherein an image signal line 106HS of the horizontal scanning system is used commonly by a plurality of pixels. Particularly, FIG. 8A illustrates an outline of a connection relationship of scanning lines (writing scanning lines 104WS, power supply lines 105DSL and image signal lines 106HS) between a number of pixel circuits P for 16 pixels (4 rows and 4 columns) and scanning sections (writing scanning section 104, driving scanning section 105 and horizontal driving section 106) of the organic EL display apparatus 1.

FIG. 8B illustrates details of the connection relationship between the pixel circuits P for 3 pixels (in one row and three columns) and scanning lines (writing scanning line 104WS, power supply line 105DSL and image signal line 106HS). FIG. 8C illustrates driving timings of the organic EL display apparatus 1 of FIG. 8A where a line-sequential driving method is applied. It is to be noted that, where description is given of a row number or an attribute of a column such as a color type or an odd/even number in the following description, a reference character to the row number or the attribute of the column like “_” is annexed. This also applies to the description given below of the other embodiments of the present invention.

Not only in the present embodiment but also in the other embodiments hereinafter described, in order for a plurality of pixels to commonly use an image signal line 106HS which is a scanning line of the horizontal scanning system or an image signal Vsig, the sampling transistor is first changed into a two-stage cascade connection configuration including a sampling transistor (first sampling transistor 125) and another sampling transistor (second sampling transistor 625). In short, the sampling transistor is configured so as to have a double-gate structure.

When both of the two sampling transistors 125 and 625 connected in cascade connection are turned on, an image signal Vsig, which may be an offset potential Vofs or a signal potential Vin, from the image signal line 106HS is supplied to the gate of the driving transistor 121. Therefore, the sampling transistors 125 and 625 cooperatively have an ANDing function. Consequently, a synthesized output of the sampling transistors 125 and 625 may be set such that, where it is a threshold value correction preparation pulse or a threshold value correction pulse, all of the sampling transistors 125 and 625 of the R, G and B pixels in one set are turned on, but where the synthesized output of the sampling transistors 125 and 625 is a signal writing pulse or a mobility correction pulse, the second sampling transistors 625 in the columns for the R, G and B for common use in accordance with signal potentials Vin_R, Vin_G and Vin_B for the different colors are turned on in order.

Further, while the controlling input terminal or gate of the first sampling transistor 125 in each column is connected such that it is controlled with a writing driving pulse WS in an ordinary manner, the second sampling transistor 625 is that, for each set of second sampling transistors 625 among which an image signal line 106HS is to be used commonly, the controlling input terminals or gates of the second sampling transistors 625 are connected to same or different kinds of vertical scanning lines in different rows of different sets (different rows) such that, for example, writing driving pulses WS for the different rows or power supply driving pulses DSL for the different rows are used as sampling controlling signals SC to carry out control. Since the writing scanning section 104 and the driving scanning section 105 are utilized for control of the second sampling transistors 625, there is an advantage that there is no necessity to prepare a scanning section for controlling the second sampling transistors 625 separately from the writing scanning section 104 and the driving scanning section 105.

Here, within an all sampling period & mobility correction period Q_all, when one of the second sampling transistors 625 is turned on for a displaying process, in the present example, for signal writing or mobility correction, since also the sampling transistors 125 of the other colors which commonly use an image signal Vsig or an image signal line 106HS are in an on state, the writing driving pulse WS for a different row or the power supply driving pulse DSL for a different row is set such that the second sampling transistors 625 of the other colors may be turned off in order to inhibit the displaying processing operation, in the present example, the signal writing or the mobility correction, for the other colors.

Further, the writing driving pulse WS for a different row or the power supply driving pulse DSL for a different row which is utilized also to control a second sampling transistor 625 is set so as to exhibit a similar transition state to the utmost between the different rows, or in other words, the basic on/off operation states of the transistor based on the writing driving pulse WS for a different row or the power supply driving pulse DSL for a different row are set so as to be established at the same time to the utmost. This is because, since the writing driving pulse WS or the power supply driving pulse DSL is utilized for the sampling controlling signal SC for controlling the second sampling transistor 625, it is intended to prevent imbalance of operation from appearing between different rows. Consequently, scanning pulses for controlling the vertical scanning lines for the different rows can be produced by applying a popular system of producing a reference pulse and successively shifting the reference pulse 1H by 1H using a shift register.

Particularly, the present embodiment is different from the other embodiments hereinafter after described in that, for each set within which an image signal line 106HS is used commonly, the gates of the second sampling transistors 625 are connected to the power supply lines 105DSL for the individually different rows such that the second sampling transistors 625 are controlled using the power supply driving pulses DSL for the different rows. In short, the present embodiment is that the controlling input terminals or gates of the second sampling transistors 625 are controlled only with the power supply driving pulses DSL for different rows irrespective of the number of object columns among which an image signal line 106HS, that is, an image signal Vsig, is used commonly. Consequently, for each set within which an image signal line 106HS is used commonly, the power supply driving pulses DSL of the different rows which are different from each other and different from the row to which the set itself belongs are used to control the other sampling transistors, that is, the other second sampling transistors 625 to reduce the number of scanning lines, that is, the image signal lines 106HS, to be led out from the horizontal driving section 106.

In order to facilitate understandings, FIGS. 8A, 8B and 8C illustrate an example wherein an image signal line 106HS for three columns is used commonly. As a typical example of three columns among which an image signal line 106HS is commonly used, the colors to be used for color display, that is, subpixels for R (red), G (green) and B (blue) as a typical example, correspond. FIGS. 8A and 8B illustrate a case wherein an image signal Vsig or an image signal line 106HS is used commonly among three columns for subpixels R, G and B for the color display which is the typical example.

In order to commonly use an image signal Vsig among three pixels adjacent each other in the horizontal direction, that is, among p pixels for three columns, each of the sampling transistors is formed in a two-stage cascade connection configuration including a first sampling transistor 125 and a second sampling transistor 625 such that it has a double-gate structure.

Then, as seen in FIG. 8A, to each of the first sampling transistors 125, a writing scanning line 104WS for the corresponding row is connected in an ordinary manner so that the first sampling transistor 125 is controlled with a writing driving pulse WS from the writing scanning section 104. Meanwhile, the second sampling transistors 625 in the R, G and B pixels are connected to power supply lines 105DSL of different rows from each other. In particular, the R pixel, that is, the pixel circuit P_R, is connected to the power supply line 105DSL_N−3 FOR the N−3th row; the G pixel, that is, the pixel circuit P_G, is connected to the power supply line 105DSL_N−2 for the N−2th row; and the B pixel, that is, the pixel circuit P_B, is connected to the power supply line 105DSL_N−1 for the N−1th row.

Since the gates of the second sampling transistors 625 of the columns for R, G and B among which the image signal Vsig is used commonly are connected to different ones of the power supply lines 105DSL in different sets or rows as can be recognized from FIGS. 8A and 8B, the power supply lines 105DSL for controlling the second sampling transistors 625 do not exist at an end portion of the pixel array section 102 in vertical scanning, in the example illustrated in FIG. 8A, at an uppermost end portion of the pixel array section 102. Thus, dummy rows for the power supply lines 105DSL should be provided.

FIG. 8C illustrates driving timings of the organic EL display apparatus 1 of the first embodiment. Not only in the present embodiment but also in the other embodiments hereinafter described, line-sequential driving is used, and the timings, particularly in a relationship of phases, of the power supply driving pulse DSL, writing driving pulse WS and image signal Vsig are defined for each set of three columns among which the image signal Vsig and the image signal line 106HS are used commonly. The following description is given paying attention to three columns for R, G and B.

First, since the first sampling transistor 125 and the second sampling transistor 625 cooperatively exhibit an ANDing function, a controlling signal synthesized by the sampling transistors 125 and 625 in the Nth row in the column for R is given as a logical AND value of a writing controlling pulse WS_N and a power supply driving pulse DSL_N−3. Meanwhile, a controlling signal synthesized by the sampling transistors 125 and 625 in the Nth row in the column for G is given as an AND value of the writing controlling pulse WS_N and another power supply driving pulse DSL_N−2, and a controlling signal synthesized by the sampling transistors 125 and 625 in the Nth row in the column for B is given as an AND value of the writing controlling pulse WS_N and a power supply driving pulse DSL_N−1.

The image signal Vsig to the columns for R, G and B is changed over such that, where a period within which the image signal Vsig is ineffective and has the offset potential Vofs is determined as a front half of one horizontal period and another period within which the image signal Vsig is effective and has the signal potential Vin (=Vofs+ΔVin) is determined as a rear half of the one horizontal period, the period of the signal potential Vin is changed over with the signal potentials Vin_R, Vin_G and Vin_B corresponding to gradations for R, G and B. In accordance with the changeover, the writing driving pulse WS is changed over such that it exhibits the active-high level in response to the signal potentials Vin_R, Vin_G and Vin_B. It is to be noted that, since on/off control by the second sampling transistor 625 acts, the writing driving pulse WS may have the active-high level within the all sampling period & mobility correction period Q_all. This similarly applies also to the other embodiments.

Incidentally, since signal writing is carried out in order like, for example, R→G→B within a period of the signal potential Vin, in order to carry out signal writing for three columns for which the image signal Vsig is synthesized, it is necessary to change over the image signal Vsig, more particularly the signal potential Vin=Vofs+ΔVin, among the signal potential Vsig_R for an R pixel, signal potential Vsig_G for a G pixel and signal potential Vsig_B for a B pixel to carry out signal writing. To this end, the signal potential Vin=Vofs+ΔVin is changed over among the signal potential Vin_R for an R pixel, signal potential Vin_G for a G pixel and signal potential Vin_B for a B pixel. Therefore, in order to implement such changeover, for example, a storage section such as, for example, a line memory is provided in the horizontal driving section 106 so as to allow changeover among the signal potentials Vin_R, Vin_G and Vin_B to be carried out rapidly.

The ratio of the period for the offset potential Vofs and the period for the signal potential Vin may be set, for example, to substantially 50% similarly as in the case of the timing chart of the third comparative example. Or, the period for the signal potential Vin may be set longer than that for the offset potential Vofs taking it consideration that the signal potential Vin is changed over among the signal potentials Vin_R, Vin_G and Vin_B corresponding to gradations for R, G and B, respectively. The period of the offset potential Vofs decreases as much and the threshold value correction period per 1H decreases as much, and the number of times of threshold value correction may be increased taking such decreases into consideration. Such alterations as described above are mere examples, and other timings may be applied.

Further, within the sampling period & mobility correction period Q_R for the R pixel within the all sampling period & mobility correction period Q_all, also inhibition of sampling & mobility correction of the other pixels is taken into consideration to set the power supply driving pulses DSL_N−2 and DSL_N−1 for the N−2th and N−1th rows, which are used also as sampling controlling signals SC_G and SC_B for controlling the second sampling transistors 625 of the G pixel and the B pixel, respectively, to the second potential Vss, whereafter the power supply driving pulses DSL_N−2 and DSL_N−1 are returned to the first potential Vcc when necessary. Similarly, within the sampling period & mobility correction period Q_G for the G pixel, the power supply driving pulses DSL_N−3 and DSL_N−1 for the N−3th and N−1th rows, which are used also as sampling controlling signals SC_R and SC_B for controlling the second sampling transistors 625 of the G pixel and the B pixel, respectively, to the second potential Vss, whereafter the power supply driving pulses DSL_N−3 and DSL_N−1 are returned to the first potential Vcc when necessary. Further, within the sampling period & mobility correction period Q_B for the B pixel, the power supply driving pulses DSL_N−3 and DSL_N−2 for the N−3th and N−2th rows, which are used also as sampling controlling signals SC_R and SC_G for controlling the second sampling transistors 625 of the R pixel and the G pixel, respectively, to the second potential Vss, whereafter the power supply driving pulses DSL_N−3 and DSL_N−1 are returned to the first potential Vcc when necessary. Thus, the sampling period & mobility correction periods Q_R, Q_G and Q_B are defined for the individual colors within an active period given by a logical AND of the writing driving pulse WS for the self row and the power supply driving pulses DSL for different rows.

Further, the power supply driving pulses DSL for the different rows used also to control the second sampling transistors 625 are set such that the transition state may be same to the utmost among the rows. In other words, the power supply driving pulses DSL are set such that the states of basic on/off operations of the power supply lines for the driving transistors 121 based on the power supply driving pulses DSL for the different rows may become same to the utmost. This is because it is intended to prevent imbalance in operation among the rows from being caused by the utilization of the power supply driving pulses DSL for the different rows as the sampling controlling signals SC for controlling the second sampling transistors 625. By this, the power supply driving pulses DSL for controlling the power supply lines 105DSL in the individual rows can be produced by applying a popular system which produces a reference pulse and successively shifts the reference pulse 1H by 1H using a shift register.

Here, as can be recognized from the timing chart illustrated in FIG. 8C, in the first embodiment, the number of times of threshold value correction is equal among the pixels in the R, G and B columns among which the image signal Vsig or the image signal line 106HS is used commonly. Incidentally, although the threshold value correction period preparation period becomes different among the pixels in the R, G and B columns among which the image signal Vsig or the image signal line 106HS is used commonly, this does not matter because the threshold value correction preparation is operation of setting the source voltage of the driving transistor 121 to the second potential Vss.

Further, since, in the system of the first embodiment, the power supply driving pulses DSL for the different rows, in the example illustrated, the power supply driving pulses DSL for the N−3th, N−2th and N−1th rows with respect to the Nth row, are set to the second potential Vss to determine the timing at which sampling of a signal potential and mobility correction are carried out, also the power supply driving pulse DSL for the self row has a period within which the second potential Vss is exhibited after a sampling period & mobility correction period. However, even if the potential of the power supply line 105DSL for the self row becomes the second potential Vss after signal writing ends, that is, even if the power supply is turned off after signal writing ends, since the storage capacitor 120 is connected between the gate and the source of the driving transistor 121 and the bootstrap function acts to keep the gate-source voltage Vgs of the driving transistor 121 fixed, when the potential of the power supply line 105DSL returns to the first potential Vcc, that is, when the power supply is turned on, the organic EL element 127 can emit light normally again and the luminance of emitted light of the organic EL element 127 does not vary.

Incidentally, the light emitting period of the organic EL element 127 is basically determined from a timing at which the writing driving pulse WS after the sampling period & mobility correction period Q is rendered inactive, that is, a turning off timing of the first sampling transistor 125, and a timing of changeover of the power supply line 105DSL, which is a power supply line, to the second potential Vss, that is, a timing at which the power supply is turned off. In the present example, after the writing driving pulse WS after the sampling period & mobility correction period Q is rendered inactive, before the potential of the power supply line 105DSL is changed over to the second potential Vss in order to enter a threshold value preparation period, the power supply driving pulses DSL_N−3, DSL_N−2 and DSL_N−1 are changed over to the second potential Vss once in order to make it possible to successively carry out signal writing and mobility correction for the pixels for R, G and B in order within the all sampling period & mobility correction period Q_all. Therefore, the point of time at which the first sampling transistor 125 is turned off after the sampling period & mobility correction period Q_R for each row becomes a light emission starting timing. Thereafter, the timing at which the power supply driving pulse DSL is changed over to the second potential Vss in order to carry out initialization before a succeeding threshold value correction operation is entered becomes a light emission ending timing. Then, the period of the time except the period within which the power supply driving pulse DSL has the second potential Vss becomes the total light emitting period.

As can be recognized from the relationship of a synthesized controlling signal by the two sampling transistors 125 and 625 within the sampling period & mobility correction period Q in the timing chart illustrated in FIG. 8C, the light emission starting timings for the pixels for R, G and B exhibit successive shifting within the rear half of 1H period. However, since the difference is only within the 1H period and is small, it may be considered that the difference among the light emitting periods for the individual colors does not matter. If this displacement matters, then, for example, the signal potentials Vin_R, Vin_G and Vin_B for the individual colors may be corrected to cope with the displacement.

Since, according to the system of the first embodiment, the gate of the second sampling transistor 625 is connected to a power supply line 105DSL for a different row so as to be controlled with a power supply driving pulse DSL for the different row, there is an advantage that there is no necessity to prepare a scanning section for controlling the second sampling transistor 625 separately from the writing scanning section 104 and the driving scanning section 105 and reduction in cost can be implemented. The number of image signal lines 106HS which are scanning lines for supplying the image signal Vsig to the first sampling transistors 125 (in fact, also to the second sampling transistors 625) without externally having surplus control circuits or controlling lines can be reduced (in the example, to ⅓) without increasing the number of controlling signals to be outputted from the vertical driving section 103 or from a scanner or a driver. Consequently, reduction in cost can be anticipated.

It is to be noted that, while, in the preceding example, the gates of the second sampling transistors 625 are connected to the power supply lines 105DSL preceding by three to one row for different colors, this is a mere example. The gates of the second sampling transistors 625 may be connected to the power supply lines 105DSL of any rows only if the power supply lines 105DSL are those for any other rows than the rows to which common use is applied. However, as the distance from the common use portion increases, the wiring line length increases, resulting in disadvantage that the number of intersections of the wiring line with the writing scanning lines 104WS increases. For example, timing differences due to increasing wiring resistance may result in an increasing cross short by intersections. Also, a problem that number of dummy rows which is provided at the end of the pixel array section 102 in vertical scanning increase may be caused. Therefore, the gate of the second sampling transistor 625 is preferable to be connected to the power supply line 105DSL close to the common use portion.

Further, while, in the preceding example, an image signal line 106HS is used commonly among three columns for the R, G and B pixels for color display, this is a mere example, and only it is necessary for an image signal Vsig of an object of common use to be used commonly by a plurality of columns but not among three adjacent columns.

Further, while, in the preceding example, an image signal line 106HS is used commonly among three columns of the subpixels R, G and B for color display, this is a mere example, and the number of objects for common use is an arbitrary number represented by k. In particular, a sampling transistor may be formed in a double gate structure such that an image signal Vsig or an image signal line 106HS is used commonly among k columns. In this instance, the second sampling transistors 625 may be connected to the power supply lines 105DSL of different rows other than the row of an object of common use such that the power supply driving pulses DSL for the different rows are used as the sampling controlling signals SC for the object row. This, however, gives rise to a disadvantage that the wiring line length increases and the number of intersections with the writing scanning lines 104WS increases and besides the number of dummy rows increases as the distance from the commonly used portion increases, similarly as in the common use among three columns.

### Improving Technique: Second Embodiment

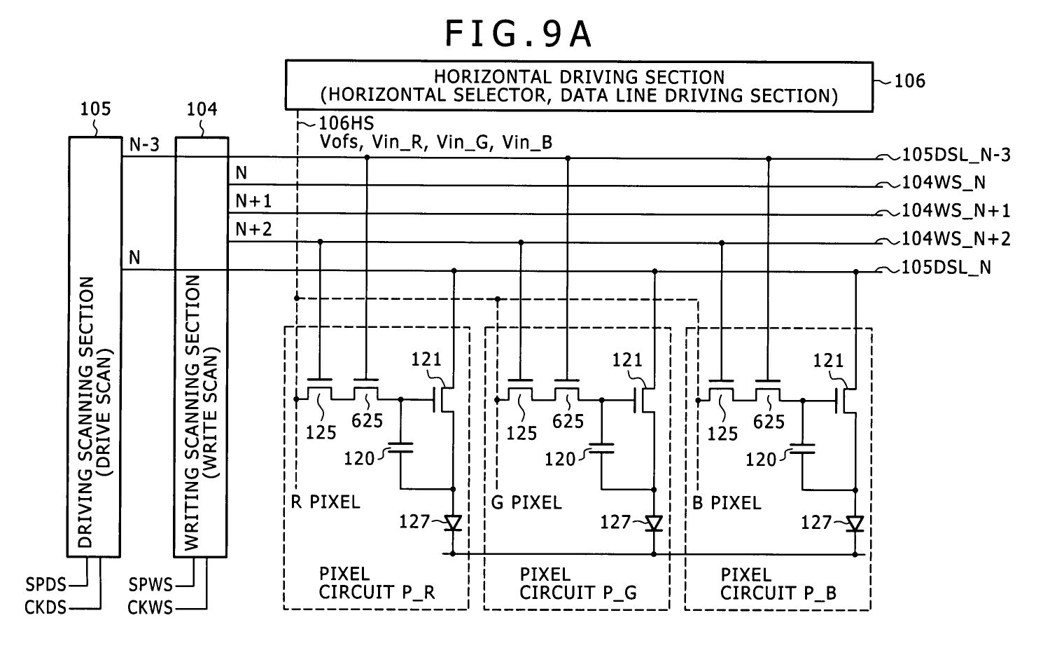

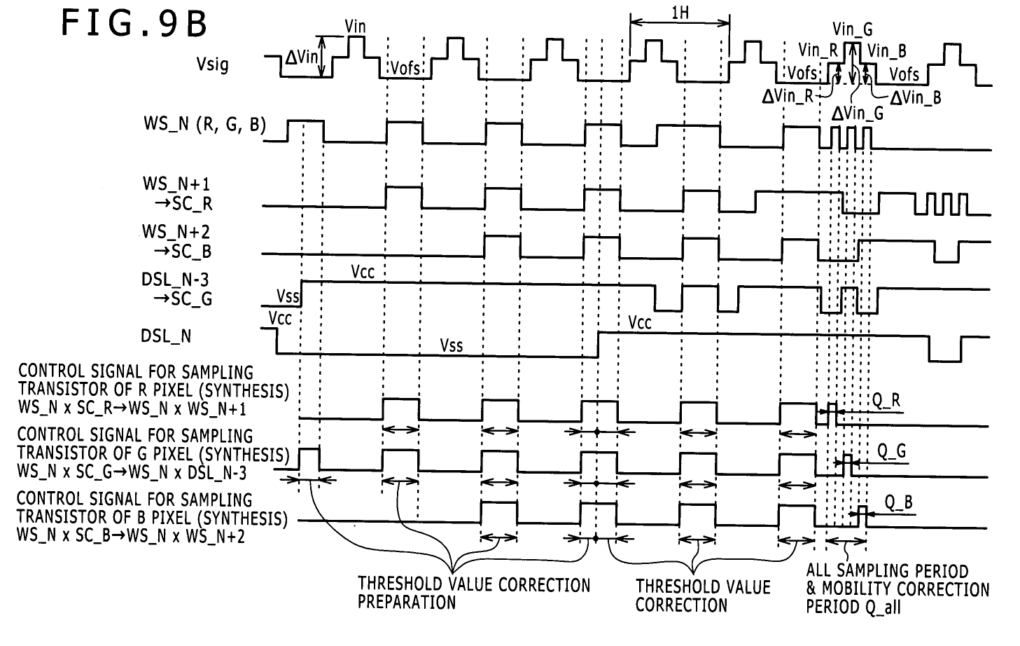

FIGS. 9A and 9B show an organic EL display apparatus according to a second embodiment of the present invention which adopts a system which supplies current to carry out signal writing thereby to carry out mobility correction and wherein an image signal line 106HS of a horizontal scanning system is commonly used by a plurality of pixels. In particular, FIG. 9A illustrates details of a connection relationship of pixel circuits P for three pixels (in one row and three columns) of the organic EL display apparatus 1 of the second embodiment and scanning lines (writing scanning line 104WS, power supply line 105DSL and image signal line 106HS). FIG. 9B illustrates driving timings of the organic EL display apparatus 1 of the second embodiment in the case of line sequential driving. FIGS. 9A and 9B illustrate a case wherein an image signal Vsig or an image signal line 106HS is used commonly among three columns for subpixels R, G and B for the color display similarly as in the first embodiment.

In the second embodiment, the pixel circuit P particularly has a double-gate structure wherein a sampling transistor is formed from a cascade connection of a first sampling transistor 125 and a second sampling transistor 625 similarly as in the first embodiment. The organic EL display apparatus 1 of the second embodiment is different from that of the first embodiment in that the controlling input terminal or gate of the second sampling transistor 625 is controlled not with only the power supply driving pulse DSL for a different row but with a combination of the writing driving pulse WS for a different row and a power supply driving pulse DSL for another different row.

In particular, the organic EL display apparatus 1 of the second embodiment is that the gate of one of the sampling transistors 625 in the columns for common use is connected to a writing scanning line 104WS for a different row except the common use portion such that the writing driving pulse WS for the different row is used as the sampling controlling signal SC to control the sampling transistor 625 and the gate of another one of the sampling transistors 625 is connected to a power supply line 105DSL for another different row except the common use portion such that the power supply pulse DSL for the another different row is used as the sampling controlling signal SC for the sampling transistor 625. In short, the writing driving pulse WS for a different row and the power supply driving pulse DSL for another different row except the common use portion (the rows are different in the common use portion) are used to control the second sampling transistors 625. By this, the number of scanning lines, that is, the number of image signal lines 106HS, to be led out from the horizontal scanning section 106 is reduced to use the image signal Vsig among a plurality of pixels.

In order to commonly use the image signal Vsig to be applied to an image signal line 106HS among three pixels adjacent to each other in the horizontal direction, that is, among three pixel circuits P for different columns for R, G and B, the sampling transistor is first changed into a two-stage cascade connection configuration including a first sampling transistor 125 and a second sampling transistor 625 similarly as in the first embodiment described hereinabove with reference to FIGS. 8A to 8C. Then, the first sampling transistors 125 of the three pixel circuits P in the different columns for the three columns for R, G and B are connected to the same image signal line 106HS such that an image signal Vsig from the horizontal driving section 106 is supplied commonly to the pixel circuits P in the three columns. Further, the controlling input terminals or gates of the sampling transistors 125 in the rows for R, G and B are connected to the writing scanning line 104WS for the self row such that the sampling transistors 125 are controlled with the writing controlling pulse WS_N in an ordinary fashion.

The gate of one of the second sampling transistors 625 in the common use portion is connected to a writing scanning line 104WS for a row different from the self row such that the second sampling transistor 625 is controlled with the writing driving pulse WS from the writing scanning line 104WS for the different row, and the gate of another one of the second sampling transistors 625 in the common use portion is connected to a power supply line 105DSL for another row different from the self row such that the another second sampling transistor 625 is controlled with the power supply driving pulse DSL from the driving scanning section 105 for the another different row. At this time, the second sampling transistors 625 in the rows for R, G and B in the common use portion use the writing driving pulse WS and the power supply driving pulse DSL in the different rows as the sampling controlling signals SC.

For example, the second sampling transistors 625 in the R, G and B pixels in the Nth row are connected particularly such that the second sampling transistor 625 in the R pixel is connected to the writing scanning line 104WS_N+1 for the N+1th line and the second sampling transistor 625 in the G pixel is connected to the power supply line 105DSL_N−3 for the N−3th row while the second sampling transistor 625 in the B pixel is connected to the writing scanning line 104WS_N+2 for the N+2th line.

As can be recognized from FIG. 9A, since the gate of one of the second sampling transistors 625 is connected to a writing scanning line 104WS or a power supply line 105DSL for a different row, it is necessary to lay a wiring line for the connection in an intersecting relationship with the writing scanning line 104WS or the power supply line 105DSL for the different row. It is to be noted that the writing scanning lines 104WS or the power supply lines 105DSL for controlling the sampling transistors 625 do not exist at an end portion of the pixel array section 102 in vertical scanning, in the example illustrated in FIG. 8A, at an uppermost portion or a lowermost portion of the pixel array section 102. Thus, dummy rows for the writing scanning lines 104WB or the power supply lines 105DSL should be provided.

As seen from FIG. 9B, the period of the signal potential Vin is changed over among the signal potentials Vin_R, Vin_G and Vin_B corresponding to gradations for R, G and B, and within the all sampling period & mobility correction period Q_all, the sampling transistors 625 in different columns used commonly for the signal potentials Vin_R, Vin_G and Vin_B for the different colors are turned on in order.

Further, within the sampling period & mobility correction period Q_R for the R pixel within the all sampling period & mobility correction period Q_all, also inhibition of sampling & mobility correction of the other pixels is taken into consideration to set the power supply driving pulse DSL_N−3 for the N−3th row, which is used also as a sampling controlling signal SC_G for controlling the sampling transistor 625 of the G pixel, to the second potential Vss, whereafter the power supply driving pulse DSL_N−3 is returned to the first potential Vcc when necessary. Further, the writing driving pulse WS_N+2 for the N+2th row, which is used also as a sampling controlling signal SC_B for controlling the sampling transistor 625 of the B pixel, is set to the inactive low level, whereafter the writing driving pulse WS_N+2 is set to the active high level when necessary.

Similarly, within the sampling period & mobility correction period Q_G for the G pixel, the writing driving pulses WS_N+1 and WS_N+2 for the N+1th and N+2th rows, which are used also as sampling controlling signals SC_R and SC_B for controlling the second sampling transistors 625 of the R pixel and the B pixel, respectively, are set to the inactive low level, whereafter the writing driving pulses WS_N+1 and WS_N+2 are set to the active high level when necessary.

Further, within the sampling period & mobility correction period Q_B for the B pixel, the writing driving pulse WS_N+1 for the N+1th row, which is used also as a sampling controlling signal SC_R for controlling the sampling transistor 625 of the R pixel is set to the inactive low level, whereafter the writing driving pulse WS_N+1 is set to the active high level when necessary. Further, the writing driving pulse WS_N−3 for the N−3th row, which is used also as a sampling controlling signal SC_G for controlling the sampling transistor 625 of the G pixel is set to the second potential Vss, whereafter the writing driving pulse WS_N+1 is returned to the first potential Vcc when necessary. Thus, the sampling period & mobility correction periods Q_R, Q_G and Q_B are defined for the individual colors within an active period given by a logical AND of the writing driving pulse WS for the self row and the writing driving pulse WS or the power supply driving pulse DSL for different row.

Further, the writing driving pulse WS and the power supply driving pulse DSL for the different rows used also to control the sampling transistors 625 are set such that the transition state may be same to the utmost among the rows. In other words, the writing driving pulse WS and the power supply driving pulse DSL are set such that the states of a basic on/off operation of the sampling transistor 125 based on the writing driving pulse WS for the different row and a basic on/off operation of the power supply line of the driving transistor 121 based on the power supply driving pulse DSL for the different row may become same to the utmost. This is because it is intended to prevent imbalance in operation among the rows from being caused by the utilization of the writing driving pulse WS or the power supply driving pulse DSL for the different row as the sampling controlling signal SC for controlling the second sampling transistor 625. By this, the writing driving pulse WS for controlling the writing scanning line 104WS for each row or the power supply driving pulse DSL for controlling the power supply line 105DSL for each row can be produced by applying a popular system which produces a reference pulse and successively shifts the reference pulse 1H by 1H using a shift register.

In this manner, although, in the system of the second embodiment, handling of control signals for controlling the second sampling transistor 625 is different from that in the system of the first embodiment, since the writing driving pulse WS or the power supply driving pulse DSL for a different row is varied to determine a timing at which signal potential sampling or mobility correction is to be carried out, also the power supply driving pulse DSL for the self row has a period within which it has the second potential Vss after a sampling period and mobility correction period. However, as can be recognized from the description in the first embodiment, the storage capacitor 120 is connected between the gate and the source of the driving transistor 121 and the bootstrap function acts so that the gate-source voltage Vgs is fixed. Therefore, when the potential of the power supply line 105DSL becomes the first potential Vcc, that is, when the power supply is turned on, the organic EL element 127 can emit light normally again.

Further, the gate of one of the second sampling transistors 625 is connected to a writing scanning line 104WS for a different row such that the second sampling transistor 625 is controlled with the writing driving pulse WS for the different row and the gate of another one of the second sampling transistors 625 is connected to a power supply line 105DSL for another different row such that the second sampling transistor 625 is controlled with the power supply driving pulse DSL for the different row. Therefore, the number of image signal lines 106HS which are scanning lines for supplying the image signal Vsig to the sampling transistors 125 (in fact, also to the second sampling transistors 625) without externally having surplus control circuits or controlling lines can be reduced (in the example, to ⅓) without increasing the number of controlling signals to be outputted from the vertical driving section 103 or from a scanner or a driver similarly as in the first embodiment.

Further, also in the present second embodiment, the number of times of threshold value correction is equal among pixels in the R, G and B rows among which the image signal Vsig or the image signal line 106HS is used commonly. Incidentally, although the threshold value correction preparation operation becomes different among different pixels by which the image signal Vsig or an image signal line 106HS is used commonly, there is no problem because the threshold value correction preparation is an operation of setting the source potential of the driving transistor 121 to the second potential Vss as recognized from the description of the first embodiment.

Further, since, also in the system of the second embodiment, the power supply driving pulse DSL for a different row is set to the second potential Vss, or in other words, the power supply to the driving transistor 121 is turned off, to determine the timing at which sampling of the signal potential or mobility correction of the signal potential for a different pixel, that is, particularly since the power supply driving pulse DSL for the N−3th row with respect to the Nth row utilized for signal writing of the R pixel and the B pixel is set to the second potential Vss to determine the timing at which sampling of the signal potential or mobility correction of the R pixel and the B pixel is to be carried out, also the power supply driving pulse DSL for the self row has a period within which it has the second potential Vss after a sampling period and mobility correction period. However, as can be recognized from the description of the first embodiment given hereinabove, even if the potential of the power supply line 105DSL for the self row becomes the second potential Vss after signal writing ends, that is, even if the power supply is turned off after signal writing ends, since the storage capacitor 120 is connected between the gate and the source of the driving transistor 121 and the bootstrap function acts to keep the gate-source voltage Vgs of the driving transistor 121 fixed, when the potential of the power supply line 105DSL returns to the first potential Vcc, that is, when the power supply is turned on, the organic EL element 127 can emit light normally again and the luminance of emitted light of-the organic EL element 127 does not vary.

### Improving Method: Third Embodiment

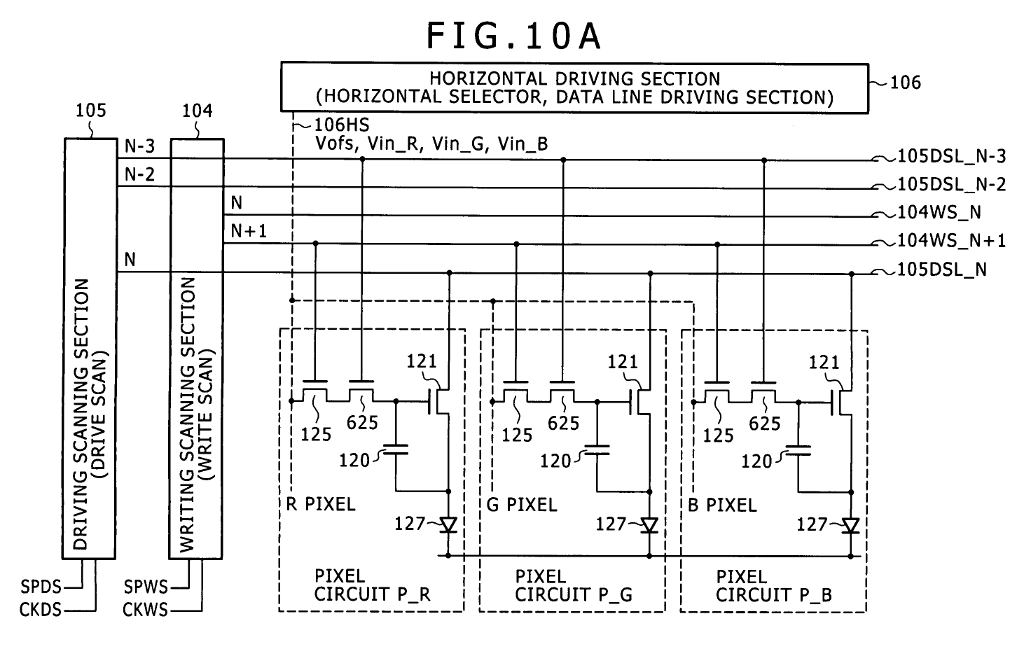

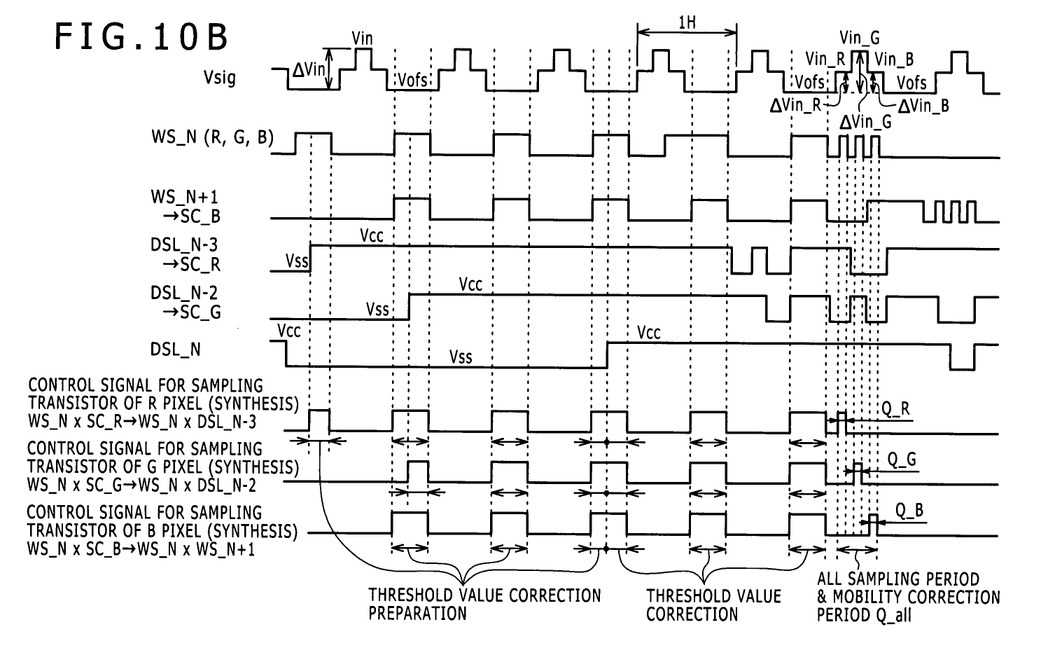

FIGS. 10A and 10B show an organic EL display apparatus according to a third embodiment of the present invention which adopts a mechanism which supplies current to carry out signal writing thereby to carry out mobility correction and wherein an image signal line 106HS of a horizontal scanning system is commonly used by a plurality of pixels. In particular, FIG. 10A illustrates details of a connection relationship of pixel circuits P for three pixels (in one row and three columns) of the organic EL display apparatus 1 of the third embodiment and scanning lines (writing scanning line 104WS, power supply line 105DSL and image signal line 106HS). FIG. 10B illustrates driving timings of the organic EL display apparatus 1 of the third embodiment in the case of line sequential driving. FIGS. 10A and 10B illustrate a case wherein an image signal Vsig or an image signal line 106HS is used commonly among three columns for subpixels R, G and B for the color display similarly as in the first and second embodiments.

The organic EL display apparatus 1 of the third embodiment is that the controlling input terminal or gate of the second sampling transistor 625 is controlled not with only the power supply driving pulse DSL for a different row but with a combination of the writing driving pulse WS for a different row and a power supply driving pulse DSL for another different row similarly as in the second embodiment. The third embodiment is considered actually same as but is different from the second embodiment only in the combination and the rows of a writing driving pulse WS and a power supply driving pulse DSL to be used as the sampling controlling signals SC.

For example, the second sampling transistors 625 in the R, G and B pixels in the Nth row are connected particularly such that the second sampling transistor 625 in the R pixel is connected to the power supply line 105DSL_N−3 for the N−3th line and the second sampling transistor 625 in the G pixel is connected to the power supply line 105DSL_N−2 for the N−2th row while the second sampling transistor 625 in the B pixel is connected to the writing scanning line 104WS_N+1 for the N+1th row.

As can be recognized from FIG. 10A, since the gate of one of the second sampling transistors 625 is connected to a writing scanning line 104WS or a power supply line 105DSL for a different row, it is necessary to lay a wiring line for the connection in an intersecting relationship with the writing scanning line 104WS or the power supply line 105DSL for the different row. It is to be noted that the writing scanning lines 104WS or the power supply lines 105DSL for controlling the sampling transistors 625 do not exist at an end portion of the pixel array section 102 in vertical scanning, in the example illustrated in FIG. 10A, at an uppermost portion or a lowermost portion of the pixel array section 102. Thus, dummy rows for the writing scanning lines 104WB or the power supply lines 105DSL should be provided.

It is to be noted that, also in the second and third embodiments, the number of those writing driving pulses WS or writing scanning lines 104WS which are used commonly is not limited to two, and setting of the row of the writing driving pulse WS or the power supply driving pulse DSL for controlling the gate of the second sampling transistor 625 is not limited to that of the examples described above only if the row is different from a row to which the writing driving pulse WS or the writing scanning line 104WS for common use belongs. It is to be noted, however, that this gives rise to a disadvantage that the wiring line length increases and the number of intersections with the writing scanning lines 104WS increases and besides the number of dummy rows increases as the distance from the commonly used portion increases, similarly as in the common use among three columns.

As seen from FIG. 10B, the period of the signal potential Vin is changed over among the signal potentials Vin_R, Vin_G and Vin_B corresponding to gradations for R, G and B, and within the sampling period & mobility correction period Q_all, the sampling transistors 625 in different columns used commonly for the signal potentials Vin_R, Vin_G and Vin_B for the different colors are turned on in order similarly as in the first and second embodiments.

Further, within the sampling period & mobility correction period Q_R for the R pixel within the all sampling period & mobility correction period Q_all, also inhibition of sampling & mobility correction of the other pixels is taken into consideration to set the power supply driving pulse DSL_N−2 for the N−2th row, which is used also as a sampling controlling signal SC_G for controlling the sampling transistor 625 of the G pixel, to the second potential Vss, whereafter the power supply driving pulse DSL_N−2 is returned to the first potential Vcc when necessary. Further, the writing driving pulse WS_N+1 for the N+1th row, which is used also as a sampling controlling signal SC_B for controlling the sampling transistor 625 of the B pixel, is set to the inactive low level, whereafter the writing driving pulse WS_N+1 is set to the active high level when necessary.

Similarly, within the sampling period & mobility correction period Q_G for the G pixel, the power supply driving pulse DSL_N−3 for the N−3th row, which is used also as a sampling controlling signal SC_R for controlling the sampling transistor 625 of the R pixel, is set to the second potential Vss, whereafter the power supply driving pulse DSL_N−3 is returned to the first potential Vcc when necessary. Further, the writing driving pulse WS_N+1 for the N+1th row, which is used also as a sampling controlling signal SC_B for controlling the sampling transistor 625 of the B pixel, is set to the inactive low level, whereafter the writing driving pulse WS_N+1 is set to the active high level when necessary.

Further, within the sampling period & mobility correction period Q_B for the B pixel, the power supply driving pulses DSL_N−3 and DSL_N−2 for the N−3th and N−2th rows, which are used also as sampling controlling signals SC_R and SC_G for controlling the sampling transistors 625 of the R pixel and the G pixel are set to the second potential Vss, whereafter the power supply driving pulses DSL_N−3 and DSL_N−2 are returned to the first potential Vcc when necessary. Thus, the sampling period & mobility correction periods Q_R, Q_G and Q_B are defined for the individual colors within an active period given by a logical AND of the writing driving pulse WS for the self row and the writing driving pulse WS or the power supply driving pulse DSL for the different row.

Further, similarly as in the second embodiment, the writing driving pulse WS and the power supply driving pulse DSL for different rows used also for controlling the second sampling transistor 625 are shifted 1H by 1H such that the transition state may be same to the utmost among the rows.

In this manner, although, in the mechanism of the third embodiment, handling of the rows of the writing driving pulse WS and the power supply driving pulse DSL for controlling the second sampling transistors 625 is different from that in the mechanism of the second embodiment, the basic concept is similar to that of the first embodiment, and the third embodiment can achieve similar advantages to those of the second embodiment.

Incidentally, where the first embodiment and the second and third embodiments are compared with each other paying attention to handling of the sampling controlling signal SC for controlling the second sampling transistor 625 having a double-gate structure, while, in the first embodiment, controlling signals of the same type, that is, the power supply driving pulses DSL for different rows, are used as the sampling controlling signals SC, in the second and third embodiments, control signals of different types, that is, the writing driving pulse WS and the power supply driving pulse DSL for different rows, are used as the sampling controlling signals SC.

From the point of view of the symmetry of operation, or from the point of view of the timing of the sampling controlling signal SC for controlling the second sampling transistor 625, the first embodiment which uses similar vertical scanning pulses of the same type, that is, the power supply driving pulses DSL, is superior. This is because, since the writing scanning line 104WS and the power supply line 105DSL are different in load from each other and, if vertical scanning pulses of different types are used to control the second sampling transistors 625 in order to use the image signal Vsig or the image signal line 106HS commonly among a plurality of columns, then there is the possibility that the difference between them may appear on a display image.

### Improving Method: Fourth Embodiment

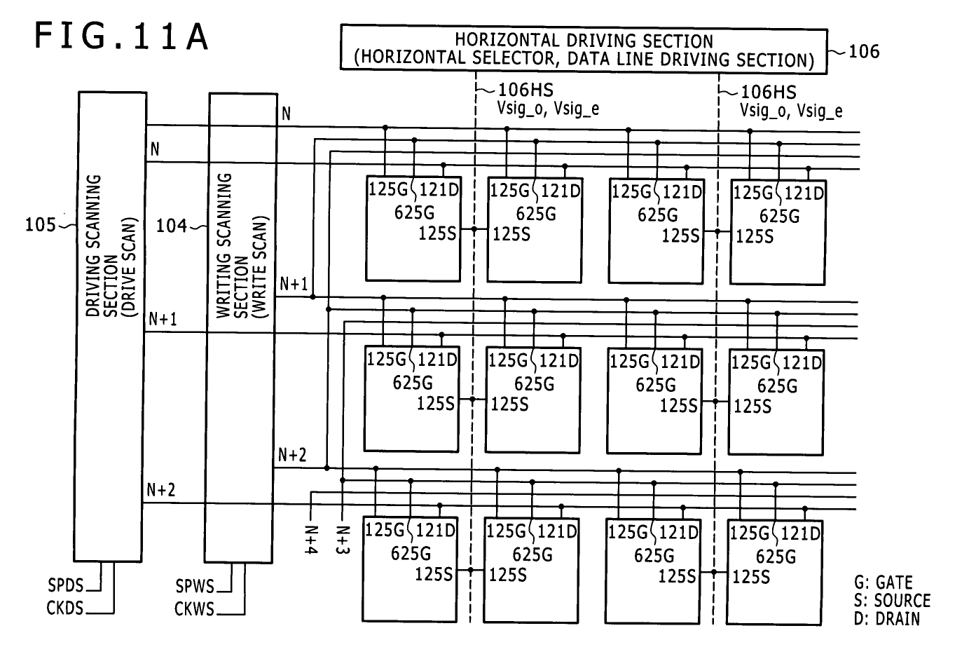

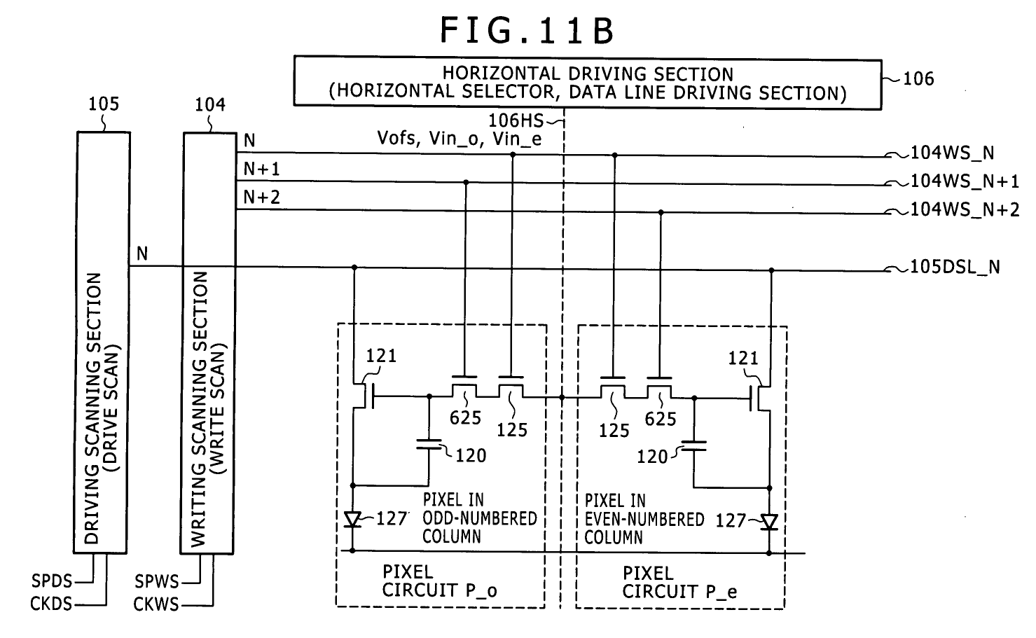

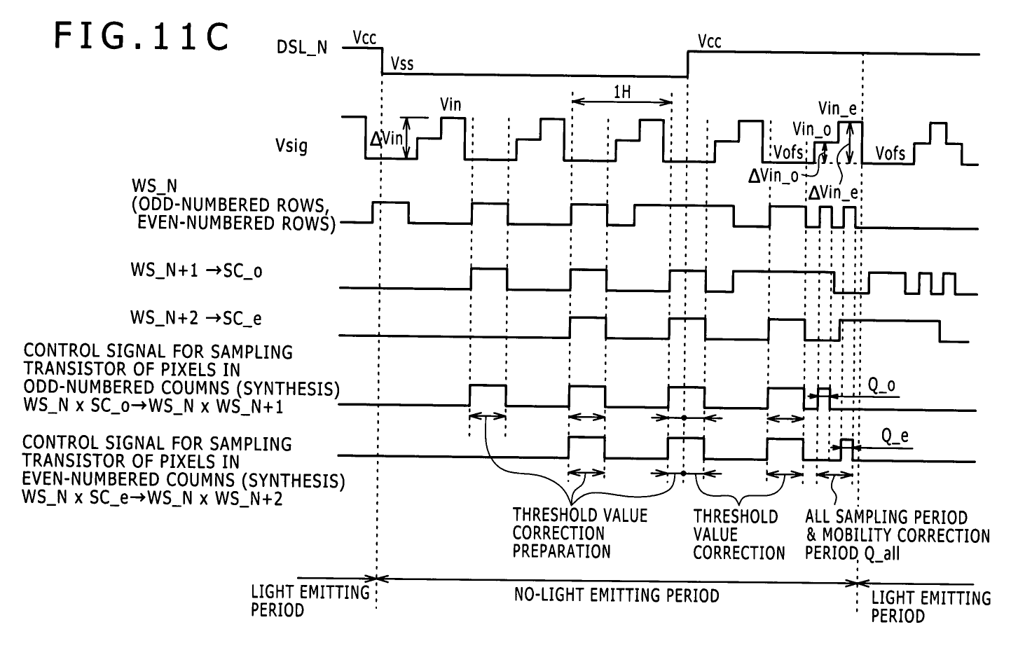

FIGS. 11A to 11C show an organic EL display apparatus according to a fourth embodiment of the present invention which adopts a mechanism for carrying out signal writing while supplying current when the organic EL element 127, which is an example of an electro-optical element of the current driven type, is driven to carry out mobility correction and wherein an image signal line 106HS of the horizontal scanning system is used commonly by a plurality of pixels. Particularly, FIG. 11A illustrates an outline of a connection relationship of scanning lines (writing scanning lines 104WS, power supply lines 105DSL and image signal lines 106HS) between a number of pixel circuits P for 16 pixels (4 rows and 4 columns) and scanning sections (writing scanning section 104, driving scanning section 105 and horizontal driving section 106) of the organic EL display apparatus 1 of the fourth embodiment. FIG. 11B illustrates details of the connection relationship between the pixel circuits P for 4 pixels (in one row and four columns) and scanning lines (writing scanning line 104WS, power supply line 105DSL and image signal line 106HS) shown in FIG. 11A. FIG. 11C illustrates driving timings of the organic EL display apparatus 1 of FIG. 11A where a line-sequential driving method is applied.

In the fourth embodiment, the pixel circuit P particularly has a double-gate structure wherein a sampling transistor is formed from a cascade connection of a first sampling transistor 125 and a second sampling transistor 625 similarly as in the first to third embodiments. The fourth embodiment is, different from the first to third embodiments, that, irrespective of the number of object columns among which an image signal line 106HS or an image signal Vsig is used commonly, the controlling input terminal or gate of each second sampling transistor 625 is controlled not with only the power supply driving pulse DSL for a different row but with only a writing driving pulse WS for a different row. Consequently, by using, for each set within which an image signal line 106HS is commonly used, writing driving pulses WS for other different rows other than the row to which the set belongs to control the other sampling transistors, that is, the other second sampling transistors 625 to reduce the number of scanning lines, that is, the number of image signal lines 106HS, to be led out from the horizontal driving section 106.

FIGS. 11A to 11C illustrate an example wherein an image signal line 106HS or an image signal Vsig is used commonly between two adjacent columns, that is, between an odd-numbered column and an even-numbered column. Here, the gate of one of the second sampling transistors 625 in the common use portion is connected to a writing scanning line 104WS for a row different from the self row such that the second sampling transistor 625 is controlled with the writing driving pulse WS from the writing scanning line 104WS for the different row, and also the gate of another one of the second sampling transistors 625 in the common use portion is connected to another writing scanning line 104WS for another row different from the self row such that the another second sampling transistor 625 is controlled with the writing driving pulse WS from the writing scanning line 104WS for the another different row. At this time, the second sampling transistors 625 in the two rows in the common use portion use the writing driving pulses WS for the different rows as the sampling controlling signals SC.

For example, the second sampling transistors 625 in the pixel circuits P_o and P_e in the Nth row are connected particularly such that the second sampling transistor 625 in the pixel circuit P_o in an odd-numbered column is connected to the writing scanning line 104WS_N+1 for the N+1th row and the second sampling transistor 625 in the pixel circuit P_e in an even-numbered column is connected to the writing scanning line 104WS_N+2 for the N+2th row.

As can be recognized from FIG. 11A, since the gate of one of the second sampling transistors 625 is connected to a writing scanning line 104WS for a different row, it is necessary to lay a wiring line for the connection in an intersecting relationship with the writing scanning lines 104WS for the different rows. It is to be noted that the writing scanning lines 104WS for controlling the sampling transistors 625 do not exist at an end portion of the pixel array section 102 in vertical scanning, in the example illustrated in FIG. 11A, at a lowermost portion of the pixel array section 102. Thus, dummy rows for the writing scanning lines 104WB should be provided.

It is to be noted that, also in the fourth embodiment, as described hereinabove in connection with the first to third embodiments, the number of writing driving pulses WS or writing scanning lines 104WS to be used for common use is not limited to two. An example is given by a fifth embodiment of the present invention. Further, setting of the row of the writing driving pulse WS for controlling the gate of the second sampling transistor 625 is not limited to the example described hereinabove only if the row is different from the row to which the set of the writing driving pulse WS or the writing scanning line 104WS to be used commonly. For example, it is only necessary for the writing driving pulse WS or the writing scanning line 104WS for controlling a second sampling transistor 625 to be any other than the pertaining row, that is, the Nth row, used for common use like the N+2th row or the N+3th row with respect to the Nth row, and the writing driving pulse WS of an arbitrary row following the N+1th row may be used. This, however, gives rise to a disadvantage that the wiring line length increases and the number of intersections with the writing scanning lines 104WS increases and besides the number of dummy rows increases as the distance from the commonly used portion increases, similarly as in the case of the common use among three columns.

As seen from FIG. 11C which illustrates driving timings of the organic EL display apparatus 1, the period of the signal potential Vin is changed over with signal potentials Vin_o and Vin_e corresponding to gradations for the pixel circuits P_o and P_e. Within the all sampling period & mobility correction period Q_all, the second sampling transistors 625 in columns used commonly are successively turned on in response to the signal potentials Vin_o and Vin_e for the pixel circuits P.

Further, within the sampling period & mobility correction period Q_o for the pixel circuit P_o for the odd-numbered row within the all sampling period & mobility correction period Q_all, also inhibition of sampling & mobility correction of the other pixels is taken into consideration to set the writing driving pulse WS_N+2 for the N+2th row, which is used also as a sampling controlling signal SC_2 for controlling the sampling transistor 625 of the pixel circuit P_e for the even-numbered row, to the inactive low level, whereafter the writing driving pulse WS_N+2 is set to the active high level when necessary. Similarly, within the sampling period & mobility correction period Q_e for the pixel circuit P_e for the odd-numbered row, the writing driving pulse WS_N+1 for the N+1th row, which is used also as a sampling controlling signal SC_1 for controlling the sampling transistor 625 of the pixel circuit P_o for the odd-numbered row, to the inactive low level, whereafter the writing driving pulse WS_N+1 is set to the active high level when necessary. Thus, each of the sampling period & mobility correction periods Q_o and Q_e for the different pixels P is defined by an active period of a logical AND of the writing driving pulse WS for the self row and the writing driving pulse WS for a different row.

Similarly as in the first to third embodiments, the writing driving pulses WS for different rows used to control the sampling transistors 625 are in a mutually shifted state by 1H such that the transition state may be same to the utmost among the rows.

In this manner, although, in the mechanism of the fourth embodiment, handling of the sampling controlling signals SC for controlling the second sampling transistors 625 is different from that in the mechanism of the first to third embodiments in that only the writing driving pulses WS for other rows except the row to which the set within which the image signal Vsig or the image signal line 106Hs is used commonly belongs are used as the sampling controlling signals SC, the basic concept is similar to that of the first to third embodiments, and the fourth embodiment can achieve similar advantages to those of the second embodiment.

For example, the number of image signal lines 106HS which are scanning lines for supplying the image signal Vsig to the sampling transistors 125 (in fact, also to the sampling transistors 625) without externally having surplus control circuits or controlling lines can be reduced (in the example, to ½) without increasing the number of controlling signals to be outputted from the vertical driving section 103 or from a scanner or a driver. Consequently, reduction in cost can be anticipated.

Further, the fourth embodiment can achieve effects similar to those of the first embodiment which utilizes only power supply driving pulses DSL for different rows in that it uses, as the sampling controlling signals SC for controlling the second sampling transistors 625, only the writing driving pulses WS for different rows irrespective of the number of object columns among which an image signal line 106HS or an image signal Vsig is commonly used. In this regard, the fourth embodiment is superior to the second and third embodiments.

Further, in the present fourth embodiment and also in the fifth embodiment hereinafter described, since, in reduction of the number of image signal lines 106HS or image signals Vsig, only a writing driving pulse WS is used as the sampling controlling signal SC for controlling the gate of the second sampling transistor 625 without using a power supply driving pulse DSL, there is an advantage that the number of image signal lines 106HS or image signals Vsig can be reduced without being influenced by the wiring scheme of the power supply lines 105DSL. This can be applied, for example, even where the power supply driving pulses DSL are not common to the panel, and further reduction in cost can be reduced.

It is to be noted that, in the present fourth embodiment, the number of times of threshold value correction is equal among the pixels in the odd-numbered columns and the even-numbered columns among which the image signal Vsig or the image signal line 106HS is used commonly. Incidentally, although the threshold value correction period preparation periods Q_o and Q_e for the pixels in the odd-numbered columns and the even-numbered columns among which the image signal Vsig or the image signal line 106HS is used commonly become different from each other, this does not matter because the threshold value correction preparation is operation of setting the source voltage of the driving transistor 121 to the second potential Vss as can be recognized from the description of the first to third embodiments.

### Improving Method: Fifth Embodiment

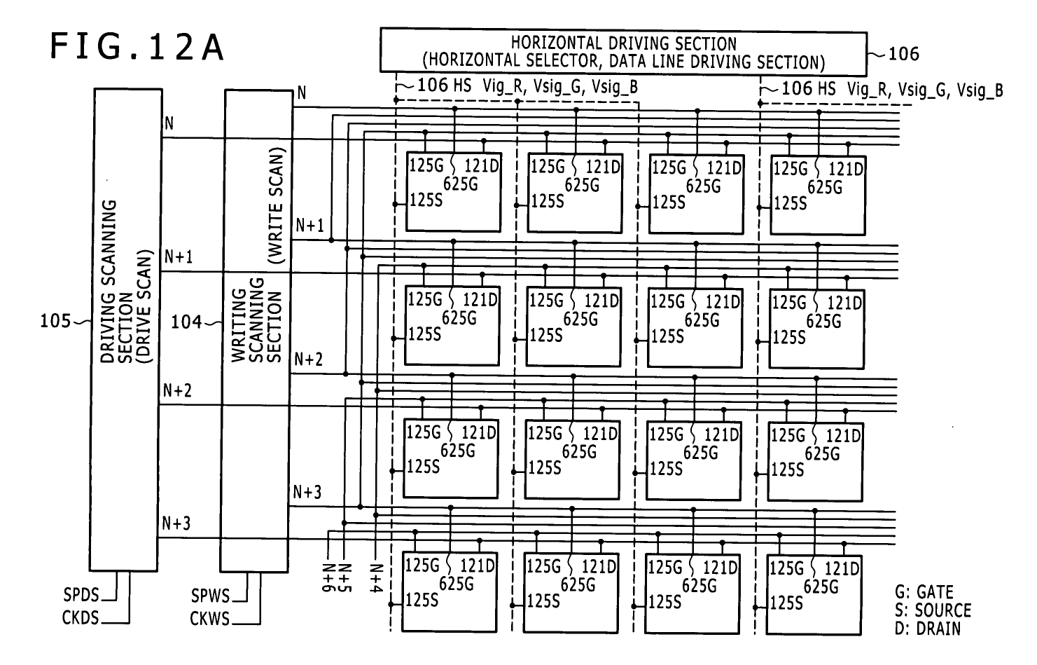

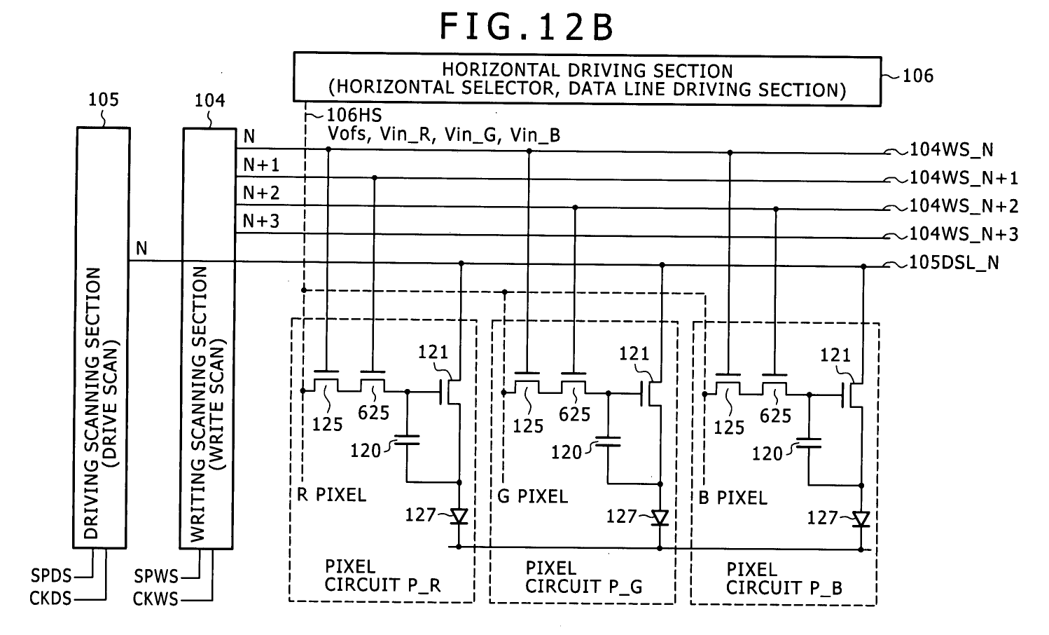

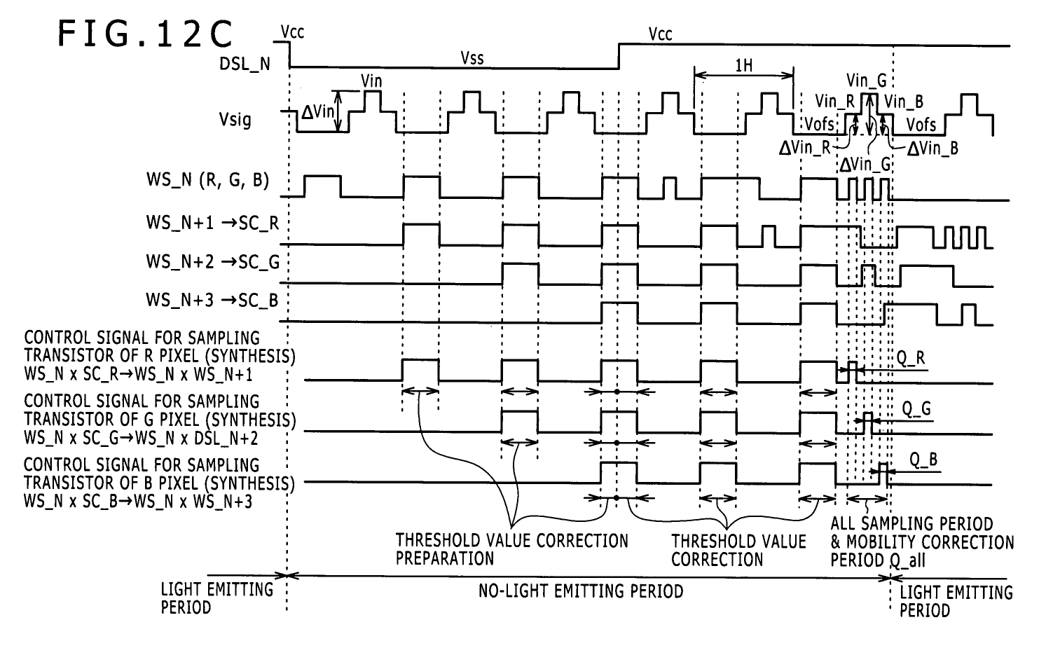

FIGS. 12A to 12C show an organic EL display apparatus according to a fifth embodiment of the present invention which adopts a mechanism for carrying out signal writing while supplying current to carry out mobility correction and wherein an image signal line 106HS of the horizontal scanning system is used commonly by a plurality of pixels. Particularly, FIG. 12A illustrates an outline of a connection relationship of scanning lines (writing scanning lines 104WS, power supply lines 105DSL and image signal lines 106HS) between a number of pixel circuits P for 16 pixels (4 rows and 4 columns) and scanning sections (writing scanning section 104, driving scanning section 105 and horizontal driving section 106) of the organic EL display apparatus 1 of the fifth embodiment. FIG. 12B illustrates details of the connection relationship between the pixel circuits P for 3 pixels (in one row and three columns) and scanning lines (writing scanning line 104WS, power supply line 105DSL and image signal line 106HS) shown in FIG. 12A. FIG. 12C illustrates driving timings of the organic EL display apparatus 1 of FIG. 12A where a line-sequential driving method is applied. In order to facilitate understandings, FIGS. 12A to 12C illustrate an example wherein an image signal Vsig or an image signal line 106HS is used commonly among three columns for subpixels R, G and B for the color display similarly as in the first to third embodiments.

In the fifth embodiment, the pixel circuit P particularly has a double-gate structure wherein a sampling transistor is formed from a cascade connection of a first sampling transistor 125 and a second sampling transistor 625 similarly as in the first to fourth embodiments. Similarly to the fourth embodiment, the fifth embodiment is configured such that, irrespective of the number of object columns among which an image signal line 106HS or an image signal Vsig is used commonly, the controlling input terminal or gate of each second sampling transistor 625 is controlled not with only the power supply driving pulse DSL for a different row but with only a writing driving pulse WS for a different row. Consequently, the number of scanning lines, that is, the number of image signal lines 106HS, to be led out from the horizontal driving section 106, is reduced. The fifth embodiment is different from the fourth embodiment only in the number of columns for common use.

In order to commonly use the image signal Vsig to be applied to an image signal line 106HS among three pixels adjacent to each other in the horizontal direction, that is, among three pixel circuits P for different columns for R, G and B, the sampling transistor is first changed into a two-stage cascade connection configuration including a first sampling transistor 125 and a second sampling transistor 625 similarly as in the first embodiment described hereinabove with reference to FIGS. 8A to 8C. Then, the first sampling transistors 125 of the three pixel circuits P in the different columns for the three columns for R, G and B are connected to the same image signal line 106HS such that an image signal Vsig from the horizontal driving section 106 is supplied commonly to the pixel circuits P in the three columns. Further, the controlling input terminals or gates of the sampling transistors 125 in the rows for R, G and B are connected to the writing scanning line 104WS for the self row such that the sampling transistors 125 are controlled with the writing controlling pulse WS_N in an ordinary fashion.

The second sampling transistors 625 are connected to the writing scanning lines 104WS in rows different from each other such that they are controlled utilizing the writing driving pulses WS for the different rows as sampling controlling signals SC similarly as in the fourth embodiment. For example, the second sampling transistors 625 in the R, G and B pixels in the Nth row are connected such that the second sampling transistor 625 in the R pixel is connected to the writing scanning line 104WS_N+1 of the N+1th row; the second sampling transistor 625 in the G pixel is connected to the writing scanning line 104WS_N+2 of the N+2th row; and the second sampling transistor 625 in the B pixel is connected to the writing scanning line 104WS_N+3 of the N+3th row.

It is to be noted that, also in the fifth embodiment, as described hereinabove in connection with the first to fourth embodiments, setting of the rows of the writing driving pulses WS for controlling the gate of the second sampling transistor 625 are not limited to those of the examples described above only if the rows are different from a row to which the writing driving pulse WS or the writing scanning line 104WS for common use belongs and are different from each other. For example, it is only necessary for the writing driving pulse WS or the writing scanning line 104WS for controlling a second sampling transistor 625 to be any other than the pertaining row, that is, the Nth row, used for common use like the N+2th row, the N+3th row and the N+4th row with respect to the Nth row, and the writing driving pulse WS of an arbitrary row following the N+1th row may be used. This, however, gives rise to a disadvantage that the wiring line length increases and the number of intersections with the writing scanning lines 104WS increases and besides the number of dummy rows increases as the distance from the commonly used portion increases, similarly as in the case of the common use among three columns.

As seen from FIG. 12C which illustrates driving timings of the organic EL display apparatus 1, the period of the signal potential Vin is changed over with signal potentials Vin_R, Vin_G and Vin_B corresponding to gradations for R, G and B. Within the all sampling period & mobility correction period Q_all, the sampling transistors 625 in the columns for common use are successively turned on in response to the signal potentials Vin_R, Vin_G and Vin_B for the individual colors.

Further, within the sampling period & mobility correction period Q_R for the R pixel within the all sampling period & mobility correction period Q_all, also inhibition of sampling & mobility correction of the other pixels is taken into consideration to set the writing driving pulses WS_N+2 and WS_N+3 for the N+2th and N+3th rows, which are used also as sampling controlling signals SC_G and SC_B for controlling the sampling transistors 625 of the G and B pixels, to the inactive low level, whereafter the writing driving pulses WS_N+2 and WS_N+3 are set to the active high level when necessary. Similarly, within the sampling period & mobility correction period Q_G for the G pixel, the writing driving pulses WS_N+1 and WS_N+3 for the N+1th and N+3th rows, which are used also as sampling controlling signals SC_R and SC_B for controlling the sampling transistors 625 of the R and B pixels, to the inactive low level, whereafter the writing driving pulses WS_N+1 and WS_N+3 are set to the active high level when necessary. Within the sampling period & mobility correction period Q_B for the B pixel, the writing driving pulses WS_N+1 and WS_N+2 for the N+1th and N+2th rows, which are used also as sampling controlling signals SC_R and SC_G for controlling the sampling transistors 625 of the R and G pixels, to the inactive low level, whereafter the writing driving pulses WS_N+1 and WS_N+2 are set to the active high level when necessary. Thus, each of the sampling period & mobility correction periods Q_R, W_G and Q_B for the different colors is defined by an active period of a logical AND of the writing driving pulse WS for the self row and the writing driving pulse WS for a different row.

Further, the writing driving pulse WS for a different row which is utilized also to control a second sampling transistor 625 is set so as to exhibit a similar transition state to the utmost among the different rows, or in other words, the basic on/off operation states of the sampling transistors based on the writing driving pulse WS for a different row are set so as to be established at the same time to the utmost. This is because, since the writing driving pulse WS for a different row is utilized for the sampling controlling signal SC for controlling the second sampling transistor 625, it is intended to prevent imbalance of operation from appearing between different rows. Consequently, the writing driving pulses WS for controlling the writing scanning lines 104WS for the different rows can be produced by applying a popular mechanism of producing a reference pulse and successively shifting the reference pulse 1H by 1H using a shift register.

In this manner, although, in the mechanism of the fifth embodiment, handling of the controlling signals for controlling the second sampling transistors 625 is similar to that in the mechanism of the fourth embodiment in that, for all of the controlling signals, the writing driving pulses WS for other rows are used and the writing driving pulse Ws for a different row is varied to determine a timing at which sampling of the signal potential or mobility correction is to be carried out. Therefore, the fifth embodiment can achieve similar advantages to those of the second embodiment.

For example, the number of image signal lines 106HS which are scanning lines for supplying the image signal Vsig to the sampling transistors 125 (in fact, also to the sampling transistors 625) without externally having surplus control circuits or controlling lines can be reduced (in the example, to ⅓) without increasing the number of controlling signals to be outputted from the vertical driving section 103 or from a scanner or a driver. Consequently, reduction in cost can be anticipated.

It is to be noted that, in the present fifth embodiment, the number of times of threshold value correction is equal among the pixels in the columns for R, G and B among which the image signal Vsig or the image signal line 106HS is used commonly. Incidentally, although the threshold value correction period preparation periods for the pixels in the columns for R, G and B among which the image signal Vsig or the image signal line 106HS is used commonly become different from each other, this does not matter because the threshold value correction preparation is operation of setting the source voltage of the driving transistor 121 to the second potential Vss as can be recognized from the description of the first to fourth embodiments.

It is to be noted that the foregoing description of the first to fifth embodiments is directed to the mechanism for commonly using an image signal Vsig or an image signal line 106HS among a plurality of columns in an application to a system which carries out, when the organic EL element 127 which is an example of an electro-optical element of the current driven type is driven, mobility correction by supplying current from the driving transistor 121 to carry out signal writing, that is, by sampling information corresponding to the signal potential Vin into the storage capacitor 120. However, the application can be applied also to a pixel circuit for which signal writing is carried out without supplying current. In other words, the application can be applied also to a system wherein mobility correction is carried out after signal writing into the storage capacitor 120 ends completely in a state wherein no current is supplied to the driving transistor 121, that is, to a system wherein signal writing and mobility correction are carried out at different timings from each other. The application can be applied also to another system wherein, after signal writing into the storage capacitor 120 in a state wherein no current is supplied to the driving transistor 121 almost ends, current is supplied to the driving transistor 121 to subsequently enter mobility correction.

For example, the application can be applied to the five-transistor configuration disclosed in Patent Document 1. In this instance, the power supply line 105DSL and the power supply driving pulse DSL in the first to fifth embodiments described above may be replaced into the scanning line DS or the controlling signal DS connected to the gate of the transistor Tr4 in the Patent Document 1 while the writing scanning line 104WS or the writing driving pulse WS is replaced into the scanning line WS or the controlling signal WS connected to the gate of the transistor Tr1 in the Patent Document 1.

Further, the first to fifth embodiments described above can be applied also to a system which carries out signal writing while carrying out mobility correction at two stages.

While preferred embodiments of the present invention have been described above with reference to the accompanying drawings, naturally the present invention is not limited to the embodiment. It is apparent that a person skilled in the art could have made various alterations or modifications without departing from the spirit and scope of the invention as defined in claims, and it is understood that also such alterations and modifications naturally fall within the technical scope of the present invention.

Further, the embodiments described above do not restrict the invention as defined in the claims. Further, all of the combination of the features described in the embodiments described above are not essentially demanded for the solving means of the present invention. The embodiments described above include inventions of various stages, and various inventions can be extracted by suitable combinations of a plurality of features indicated in the embodiments. Even if some features are deleted from all of the features indicated in the embodiments, the remaining features after such deletion may possibly be extracted as an invention.

### <Modified Pixel Circuits>

For example, the first to fifth embodiments can be modified from an aspect of the pixel circuit P. For example, since the “principle of duality” applies in the circuit theory, the pixel circuit P can be modified from this point of view. In this instance, though not shown, the pixel circuit P is formed using a p-type driving transistor 121 while the pixel circuit P in the embodiments described above is formed using an n-type driving transistor 121. In conformity with this, the pixel circuit P is modified in accordance with the principle of duality such as to reverse the polarity of the signal amplitude ΔVin with respect to the offset potential Vofs of the image signal Vsig and the relationship in magnitude of the power supply voltage.

For example, in a pixel circuit P of a modified form according to the “principle of duality,” the storage capacitor 120 is connected between the gate terminal and the source terminal of a driving transistor of the p type (hereinafter referred to as p-type driving transistor 121p), and the source terminal of the p-type driving transistor 121p is connected directly to the cathode terminal of the organic EL element 127. The organic EL element 127 is connected at the anode terminal thereof to an anode potential Vanode as a reference potential. The anode potential Vanode is connected to a reference power supply on the high potential side common to all pixels which supplies a reference potential. The p-type driving transistor 121p is connected at the drain terminal thereof to a second potential Vss on the low potential side and supplies driving current Ids to the organic EL element 127 so as to emit light from the organic EL element 127.

Also in an organic EL display apparatus of the modified form wherein a p-type transistor is used as the driving transistor 121 applying the principle of duality, a threshold value correction operation, a mobility correction operation and a bootstrap operation can be executed similarly as in the organic EL display apparatus wherein an n-type transistor is used as the driving transistor 121.

When such a pixel circuit P as described above is driven, if the sampling transistors are formed in a double-gate structure and the sampling transistors 125 from among the sampling transistors are scanned with an ordinary writing driving pulse WS while the second sampling transistors 625 are controlled using, as the sampling controlling signal SC therefor, a writing driving pulse WS or a power supply driving pulse DSL for a row other than the self row in which an image signal line 106HS or an image signal Vsig is commonly used similarly as in the first to fifth embodiments described hereinabove, then the number of image signal lines 106HS which are scanning lines for supplying the image signal Vsig to the sampling transistors 125 (in fact, also to the sampling transistors 625) without externally having surplus control circuits or controlling lines can be reduced without increasing the number of controlling signals to be outputted from the vertical driving section 103 or from a scanner or a driver. Consequently, reduction in cost can be anticipated.

It is to be noted that, while the modified form of the pixel circuit P described above is obtained by modifying the configuration in the first to fifth embodiment in accordance with the “principle of duality,” the technique for modifying the circuit is not limited to this. In particular, whether or not the pixel circuit P has a two-transistor configuration does not matter only if the pixel circuit P is configured such that, when it executes a threshold value correction operation, the image signal Vsig which changes over between the offset potential Vofs and the signal potential Vin (=Vofs+ΔVin) within each horizontal period in synchronism with scanning by the writing scanning section 104 and switching driving of the drain side, that is, the current supplying side, of the driving transistor 121 is carried out between the first potential and the second potential in order to carry out an initialization operation for threshold value correction, and the number of transistors may be three or more. The concept of the embodiments of applying the improving methods of the embodiments described above wherein a sampling transistor is formed in a double-gate structure to reduce the number of image signal lines 106HS or image signals Vsig to achieve reduction of the cost can be applied to all of such pixel circuits as described above.

Further, the mechanism for supplying the offset potential Vofs and the signal potential Vin to the gate of the driving transistor 121 upon execution of the threshold value correction operation is not limited to the mechanism which uses the image signal Vsig in such a manner as that by the two-transistor configuration of the embodiments described hereinabove but may be, for example, such a mechanism which supplies such potentials as described above through a different transistor as disclosed in Patent Document 1. Also to such modifications, the concept of the embodiments described above that the improving techniques of the embodiments wherein a sampling transistor is formed in a double-gate structure may be applied to reduce the number of image signal lines 106HS or image signals Vsig to achieve reduction of the cost can be applied.

The present application contains subject matter related to that disclosed in Japanese priority Patent Application JP 2008-089981 filed in the Japan Patent Office on Mar. 31, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus, comprising:
a plurality of pixel circuits disposed in rows and columns and each including a driving transistor configured to produce driving current, an electro-optical element connected to an output terminal of said driving transistor, a storage capacitor configured to store information corresponding to a signal amplitude of an image signal, and a first sampling transistor and a second sampling transistor connected in cascade connection for writing the information corresponding to the signal amplitude into said storage capacitor;
a vertical scanning section configured to produce a vertical scanning pulse for vertically scanning said pixel circuits;
a plurality of vertical scanning lines connected to said vertical scanning section;
a horizontal scanning section configured to supply the image signal to said pixel circuits in synchronism with the vertical scanning by said vertical scanning section; and
a plurality of horizontal scanning lines connected to said horizontal scanning section;
said vertical scanning section including a writing scanning section configured to at least scan said pixel circuits vertically to produce a writing scanning pulse for writing the information corresponding to the signal amplitude into said storage capacitor,
said vertical scanning lines including a plurality of writing scanning lines connected to said writing scanning section,
each of said horizontal scanning lines being wired such that the image signal for signal writing from said horizontal scanning section is supplied commonly to the input terminals of those of said first sampling transistors which are included in a plurality of columns,
the controlling input terminals of those of said second sampling transistors which belong to each of sets each including the plurality of columns to which the image signal is supplied commonly being connected to said vertical scanning lines such that the vertical scanning pulses for the rows different from each other of other sets than the set to which the second sampling transistors belong are supplied from said vertical scanning section to the controlling input terminals of the second sampling transistors.

2. The display apparatus according to claim 1, wherein the second sampling transistors are connected at the controlling input terminal thereof to those of said vertical scanning lines which are of a similar type such that the vertical scanning pulses for vertical scanning of the same type in different rows of the different sets are supplied thereto from said vertical scanning section.

3. The display apparatus according to claim 2, wherein the vertical scanning lines of the same type are the writing scanning lines.

4. The display apparatus according to claim 2, wherein said vertical scanning section includes a driving scanning section configured to switchably supply a first potential to be used to supply the driving current to said electro-optical element and a second potential different from the first potential to a power supply terminal of said driving transistor;
said vertical scanning lines including a plurality of power supply lines which extend between said driving scanning section and the power supply terminals of the driving transistors in the individual rows,
the vertical scanning lines which are of the same type being said power supply lines.

5. The display apparatus according to claim 1, wherein the second sampling transistors are connected at the controlling input terminal thereof to those of said vertical scanning lines which are of different types such that the vertical scanning pulses for vertical scanning of different types for different rows in other sets are supplied from said vertical scanning section to the controlling input terminals of the second spring transistors.

6. The display apparatus according to claim 1, wherein
said horizontal scanning section changes over the image signals for the individual columns in order in synchronism with the vertical scanning by said vertical scanning section to supply the image signals to the pixel circuits for each of the sets of the plural columns to which the image signals are supplied commonly; and
said vertical scanning section vertically scans the first sampling transistors with the writing driving pulse and sets the vertical scanning pulses of the same or different types for vertical scanning such that, within an all display process period after a period for a display process for one of those columns among which the image signal is used commonly in each set within which the image signal is supplied commonly is entered until the display process for all of the columns among which the image signal is used commonly, the second sampling transistors are successively and selectively rendered conducting in synchronism with the conduction of the first sampling transistors so that the display process is carried out in order.

7. The display apparatus according to claim 6, wherein said vertical scanning section sets the vertical scanning pulses of the same or different types for vertical scanning such that, within the all display process period, all of the second sampling transistors in the plural columns except that one which is currently controlled to the conducting state are turned off.

8. The display apparatus according to claim 6, wherein said vertical scanning section sets the vertical scanning pulse such that, within the vertical scanning period within which the second sampling transistors need not be rendered conducting in order, both of the first and second sampling transistors are rendered conducting so that an ordinary display process is carried out.

9. The display apparatus according to claim 6, wherein said vertical scanning section sets the vertical scanning pulse such that the variation state of the vertical scanning pulse may be uniform among the different rows.

10. The display apparatus according to claim 6, further comprising a driving signal fixing circuit configured to keep the driving current fixed.

11. The display apparatus according to claim 10, wherein said driving signal fixing circuit implements a threshold value correction function of rendering said first and second sampling transistors conducting to store a voltage corresponding to a threshold voltage of said driving transistor into said storage capacitor within a time zone within which a voltage corresponding to a first potential used to supply the driving current to said electro-optical element is supplied to a power supply terminal of said driving transistor and the image signal is a reference potential.

12. The display apparatus according to claim 10, wherein said vertical scanning section includes a writing scanning section configured to vertically scan said pixel circuits to supply a writing scanning pulse for writing information corresponding to the signal amplitude into the storage capacitors to the controlling input terminal of the first sampling transistors, and a driving scanning section configured to switchably supply a first potential to be used to supply the driving current to said electro-optical element and a second potential different from the first potential to a power supply terminal of said driving transistor;
said horizontal scanning section supplying an image signal, which is changed over between a reference potential and a signal potential, to said sampling transistor,
said driving signal fixing circuit implementing a threshold value correction function of rendering said first and second sampling transistors conducting to store a voltage corresponding to a threshold voltage of said driving transistor into said storage capacitor within a time zone within which a voltage corresponding to the first potential is supplied to the power supply terminal of said driving transistor and the image signal is a reference potential under the control of said writing scanning section, horizontal driving section and driving scanning section.

13. The display apparatus according to claim 10, wherein said driving signal fixing circuit implements a mobility correction function for suppressing dependency of the driving current upon the mobility of said driving transistor.

14. The display apparatus according to claim 13, wherein said driving signal fixing circuit renders both of said first and second sampling transistors conducting within a time zone within which the image signal has a signal potential after an operation of the threshold value correction function for storing a voltage corresponding to the threshold voltage of said driving transistor into said storage capacitor to implement the mobility correction function when information corresponding to the signal potential is written into said storage capacitor.
